(19) United States
(12) Patent Application Publication
(10) Pub. No.: US 2026/0352048 A1
(43) Pub. Date: Nov. 5, 2026

(54) ROTOR FOR AN AXIAL FLUX MACHINE

(71) Applicant: Schaeffler Technologies AG & Co. KG, Herzogenaurach (DE)

(72) Inventors: Roland Schwarz, Allersberg (DE); Axel Brenzinger, Rheinstetten (DE); Johann Oswald, Eschenlohe (DE); Daniel Mahler, Hofstetten (DE); Carsten Sonntag, Gauting-Königswiesen (DE)

(73) Assignee: Schaeffler Technologies AG & Co. KG, Herzogenaurach (DE)

(21) Appl. No.: 19/487,459

(22) PCT Filed: May 14, 2024
(86) PCT No.: PCT/DE2024/100438

§ 371 Date: Nov. 24, 2025

(30) Foreign Application Priority Data
May 25, 2023 (DE) 10 2023 113 744.1

(51) Int. Cl. H02K 1/2795

(52) U.S. Cl. CPC H02K 1/2795

(57) ABSTRACT

A rotor for an axial flux machine, in particular for an axial flux machine within the powertrain of a motor vehicle, includes an inner ring and an outer ring arranged coaxially thereto, wherein magnet elements are arranged between the inner ring and the outer ring, and reinforcing braces which extend between the inner ring and the outer ring in the radial direction are arranged in the manner of spokes. A respective magnet element is arranged on both sides of each reinforcing brace in the circumferential direction and is operatively connected to one reinforcing brace such that a force component which is produced by a centrifugal force acting on the magnet elements during the operation of the rotor can be transmitted from a magnet element to a reinforcing brace and/or vice versa.

### CROSS REFERENCE TO RELATED APPLICATIONS

This application is the United States National Phase of PCT Appln. No. PCT/DE2024/100438 filed May 14, 2024, which claims priority to German Application No. DE 10 2023 113 744.1, filed May 25, 2023, the entire disclosures of which are incorporated by reference herein.

### FIELD OF INVENTION

The present invention relates to a rotor for an axial flux machine, in particular for an axial flux machine within a powertrain of a motor vehicle, including an inner ring and an outer ring arranged coaxially thereto, and magnet elements arranged between the inner ring and the outer ring.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

A detailed description of an electric drive can be found in an article in the German automotive magazine ATZ, volume 113, 05/2011, pages 360-365 by Erik Schneider, Frank Fickl, Bernd Cebulski and Jens Liebold with the title: “Hochintegrativ und flexibel—Elektrische Antriebseinheit für E-Fahrzeuge” [Highly Integrative and Flexible—Electric Drive Unit for Electric Vehicles], which would appear to be the closest prior art. This article describes a drive unit for an axle of a vehicle, which includes an electric motor arranged to be coaxial with a bevel gear differential. Such drive units are also referred to as e-axles or electrically drivable powertrains.

Increasingly, axial flux machines are also used in such e-axles. An axial flux machine is a dynamo-electric machine in which the magnetic flux between the rotor and stator extends parallel to the rotational axis of the rotor.

Often, both the stator and the rotor are configured to be largely disc-shaped.

Axial flux machines are particularly advantageous when the axially available installation space is limited in a given application. This is often the case, for example, with the electric drive systems for electric vehicles described at the outset. In addition to the shortened axial installation length, a further advantage of the axial flux machine is its comparatively high torque density. This is due to the larger air gap surface area available for a given installation space compared with radial flux machines. Furthermore, a smaller volume of iron is required compared to conventional machines, which has a positive effect on the efficiency of the machine.

Due to its disc-shaped main components, the axial flux machine is particularly well suited for applications in which a very short overall installation length of the electric motor is important and a relatively large motor diameter is still acceptable. When developing corresponding axial flux machines, it is therefore generally advisable to aim for the most compact design possible, while ensuring the outer diameter of the axial flux machine is not larger than necessary. In the case of axial flux machines for motor vehicles, there are also always requirements for low weight, high power density and low costs.

### SUMMARY

The object of the disc-shaped rotor, among other things, is to transmit the force acting on the rotor magnets to the rotor shaft. In addition to the circumferential direction, the magnets are held in both the radial and axial direction or position between the stator.

The centrifugal forces acting in or on the rotor, which are caused in particular by the magnets. Due to the centrifugal force and the outwardly extending components, unfavorable circumferential tensile stresses arise between and within the components of the rotor.

It is therefore an object of the present disclosure to provide an improved rotor for an axial flux machine which at least mitigates or even completely avoids the disadvantages known from the prior art.

This object is addressed by a rotor for an axial flux machine, in particular for an axial flux machine within a powertrain of a motor vehicle, including an inner ring and an outer ring arranged coaxially thereto, and magnet elements arranged between the inner ring and the outer ring, wherein reinforcing braces extending between the inner ring and the outer ring in the radial direction are arranged in the manner of spokes, wherein a respective magnet element is arranged on both sides of each reinforcing brace in the circumferential direction and is operatively connected to the reinforcing brace such that a force component which is produced by the centrifugal force acting on the magnet elements during the operation of the rotor can be transmitted from a magnet element to a reinforcing brace and/or vice versa.

Thereby, the advantage is achieved in that the introduction of reinforcing braces allows the magnets of the rotor to be clamped into a closed stiffness ring. This makes it possible to transfer loads from the magnet elements into the reinforcing braces, which transfer the centrifugal loads of the magnet elements into the outer ring at defined points or areas. Furthermore, the axial stiffness of the rotor can be increased by the bending stiffness of stiffening elements.

In an embodiment of the present disclosure, the stiffening elements may also be used to pretension a bandage element at additional points by means of an interference fit on the shaft, and to polygonalize it in the process, thereby bringing it into a preconditioned state for load absorption.

The individual elements of the claimed subject matter of the present disclosure are explained first in the order in which they are mentioned in the claims, after which embodiments of the subject matter of the invention are described.

The magnetic flux in an electric axial flux machine (AFM), such as an electric drive machine of a motor vehicle formed as an axial flux machine, is directed axially to a direction of rotation of the rotor of the axial flux machine in the air gap between the stator and the rotor.

Depending on the application, it can be advantageous to configure an axial flux machine in an I-arrangement or an H-arrangement. In an I-arrangement, the rotor is arranged to be axially adjacent to a stator or between two stators. In an H-arrangement, two rotors are arranged on opposite axial sides of a stator. The axial flux machine according to the present disclosure is configured in an I-arrangement.

In principle, it is also possible for a plurality of rotor-stator configurations to be arranged axially adjacent to each other as an I-type and/or H-type. In this context, it would also be possible to arrange a plurality of I-type rotor-stator configurations adjacent to each other in the axial direction. In particular, it is also contemplated for the H-type and/or I-type rotor-stator configurations each to be formed substantially identically such that they can be assembled in a modular manner to form an overall configuration. Such rotor-stator configurations can in particular be arranged to be coaxial with each other and can be connected to a common rotor shaft or to a plurality of rotor shafts.

The stator of the electric axial flux machine according to the present disclosure has a stator body with a plurality of stator windings arranged in the circumferential direction. As viewed in the circumferential direction, the stator body can be formed in one part or be segmented. The stator body can be formed from a stack of stator laminations with a plurality of laminated electrical sheets. Alternatively, the stator body can also be formed from a compressed soft magnetic material, such as what is termed an SMC (soft magnetic compound) material.

The stator is accommodated in a housing. The housing can be formed in one part or multiple parts. The housing is in particularl made of a plastic. The housing can be designed to be closed on all sides. It is also possible to provide openings in the housing, for example to reduce weight or to provide access to a component.

The magnet elements can, for example, be designed as permanent magnets. The magnet elements are designed to be substantially identical.

A rotor shaft is a rotatably mounted shaft of an electric machine to which the rotor or rotor body is coupled in a non-rotatable manner.

The electric axial flux machine can furthermore have a control device. A control device, as used in the present disclosure, serves in particular for the electronic control and/or regulation of one or a plurality of technical systems of the electric axial flux machine.

The electric axial flux machine is intended in particular for use within a powertrain of a hybrid or fully electrically driven motor vehicle. In particular, the electric machine is dimensioned such that vehicle speeds of more than 50 km/h, such as more than 80 km/h, and in particular more than 100 km/h can be achieved. The electric motor has an output of more than 30 KW, such as more than 50 kW, and in particular more than 70 KW. Furthermore, it is contemplated for the electric machine to provide rotational speeds greater than 5000 rpm, particularly greater than 10,000 rpm, most particularly greater than 12,500 rpm.

The electric axial flux machine can also be installed in an electrically operated axle powertrain. An electric axle powertrain of a motor vehicle includes an electric axial flux machine and a transmission, wherein the electric axial flux machine and the transmission form a structural unit. In particular, it can be provided that the electric axial flux machine and the transmission are arranged in a common powertrain housing. Particularly, such a powertrain housing can also form a connection structure for the axial flux machine. Alternatively, it would of course also be possible for the electric axial flux machine to have a motor housing and the transmission to have a transmission housing, wherein the structural unit can then be achieved by fixing the transmission in place in relation to the electric axial flux machine. This structural unit is sometimes also referred to as an e-axle.

### Magnet Element

A magnet element has a longitudinal extent and features a circumferential contour, wherein on a first side, which faces a first direction of rotation of the rotor when the magnet element is installed in the rotor, a longitudinally extending first planar surface portion and a longitudinally extending second planar or freely formed surface portion are formed, wherein, when the magnet element is installed in the rotor, the first surface portion is positioned radially above the second surface portion, and on a second side, which faces a second direction of rotation of the rotor when the magnet element is installed in the rotor, a longitudinally extending third planar surface portion and a longitudinally extending fourth planar or freely formed surface portion are formed.

When the magnet element is installed in the rotor, the third surface portion is positioned radially above the fourth surface portion, wherein a first plane extending through the first surface portion and a third plane extending through the third surface portion intersect radially above the magnet element in the direction of the longitudinal extent when the magnet element is installed in the rotor, and a second plane extending through the second surface portion and a fourth plane extending through the fourth surface portion intersect radially below the magnet element in the direction of the longitudinal extent when the magnet element is installed in the rotor.

This provides the advantage that, in particular, over the first planar surface portion and the third planar surface portion, a straight and planar, precisely and economically producible surface can be provided in a partial area of the circumferential contour of the magnet element, which surface can be well sealed in an injection molding or bonding process to form the rotor. Furthermore, the first planar surface portion and the third planar surface portion permit a particularly precise radial positioning of the magnet elements.

Furthermore, the first planar surface portion and the third planar surface portion can establish a “center of mass to contact surface” relationship of the magnet element. They can therefore be used as a reference when sorting or assigning the magnet elements relative to the position of their center of mass. This enables geometric balancing or allows rotor imbalance to be minimized through geometric sorting.

Sorting and/or arranging the magnet elements to reduce imbalance can then be carried out additionally or in combination by considering the weight of the magnet elements. The accuracy of the positioning of the magnet elements is thereby optimized in order to minimize the imbalance caused by uneven positioning of the sorted magnet elements in the rotor. The accuracy of rotor balance—influenced by the magnet elements—is thus optimized by sorting the magnets, taking account of deviations in geometry and mass, and assigning them to a specific position in the rotor.

The first planar surface portion and the third planar surface portion thus provide regions along the circumferential magnet contour, which are geometrically simplified (planar, straight surface portions) and can therefore be manufactured cheaply and precisely. As already mentioned above, they can also be used as a sealing surface during production.

Wherein a first plane extending through the first surface portion and a third plane extending through the third surface portion intersect radially above the magnet element in the direction of the longitudinal extent when the magnet element is installed in the rotor, the first planar surface portion and the third planar surface portion have contact lines that have an outward closing direction and can therefore be used as a positioning option for the magnet element in rotor production.

The circumferential contour of the magnet elements can, for example, be implemented directly in a sintering tool, on the individual discs of a laminated magnet element or on the entire magnet. The geometric features of the circumferential contour can be formed before passivation or after passivation with additional passivation or subsequent processes with a passivating effect. They can be used on both segmented and complete magnets. The geometric details of the circumferential contour can be implemented symmetrically or asymmetrically and/or in portions on or in the circumferential contour.

For the purposes of this present disclosure, a planar surface portion is a flat two-dimensional surface. This means that for any two points in a surface portion, a straight line will lie completely within the surface portion. The surface portion itself can also have localized unevenness, in which case an average plane is placed through the corresponding surface portion.

The magnet elements can, for example, be designed as permanent magnets. The magnet elements are designed to be substantially identical.

According to an advantageous embodiment of the present disclosure, it can be provided that the magnet element is formed mirror-symmetrically with respect to its longitudinal extent. The advantage of this embodiment is that the ease of assembly and balancing of the rotor can be improved.

According to a further development of the present disclosure, it can also be provided that the circumferential contour has, at least in portions, a chamfer which is formed at the transition between the circumferential contour and an axial surface. By providing a contour in the transition from the axial to the circumferential magnet region, adhesive joints in these regions can be relieved or their load-bearing capacity can be increased.

The chamfer also enables a more elastic connection to an injection-molded or adhesive surface.

Furthermore, according to a likewise advantageous embodiment of the present disclosure, it can be provided that the first planar surface portion and/or the second planar or freely formed surface portion and/or the third planar surface portion and/or the fourth planar or freely formed surface portion each have, at least in portions, structures protruding from or recessed into the respective planar surface. This makes it possible, in particular, to provide macroscopic shape details on one or a plurality of surface portions of the magnet element, which details improve transmission of the (centrifugal) forces to the corresponding adhesive surfaces and/or directly overmolded regions in the installed state of the magnet element.

According to a further embodiment of the present disclosure, it can be provided that the circumferential contour has a fifth surface portion which, when installed in the rotor, is oriented radially outwardly and connects the first surface portion to the third surface portion, wherein the fifth surface portion has a circular arc-shaped contour with an axis of rotation extending coaxially to an axis of rotation of the rotor. By specifying the circular arc-shaped, radially outer contour, uniform (centrifugal force) load transmission to the supporting components, such as the auxiliary bandage or load bandage, of the rotor can be enabled for unlaminated and laminated magnet elements.

Furthermore, the present disclosure can also be further developed in such a way that the circumferential contour has a sixth surface portion which, when installed in the rotor, is oriented radially inwardly and connects the second surface portion to the fourth surface portion, wherein the sixth surface portion has a chamfer which is formed at the transition between the sixth surface portion and an axial surface. This allows a wedge-like shape of the sixth surface portion, which can, for example, improve the connection to an inner ring of the rotor.

In principle, it is possible for a magnet element to be positioned via contact surfaces, but also via contact points.

In a likewise embodiment variant of the present disclosure, it can also be provided that the magnet element has an upper region and a lower region, wherein the upper region extends above half of the longitudinal extent of the magnet element and the lower region extends below half of the longitudinal extent of the magnet element, and the first surface portion and the third surface portion extend exclusively within the upper region of the magnet element. This allows balancing or defined positioning of the magnet element in the rotor through the upper region of the magnet element.

Furthermore, it is also conceivable that balancing of the rotor is realized through the lower region.

It may also be advantageous to further develop the present disclosure in such a way that the magnet element is laminated or monolithically formed.

### Coupling Elements

It is further contemplated for a coupling element to be arranged on both sides of each of the reinforcing braces in the circumferential direction between one of the magnet elements and the corresponding reinforcing brace, wherein the coupling elements are formed from a material that differs from the inner ring and/or the outer ring and/or the magnet elements and/or the reinforcing braces.

In principle, it would also be conceivable for at least one coupling element to be arranged between each pair of circumferentially adjacent magnet elements, which coupling element is coupled to at least one of the magnet elements in a force-transmitting manner in the radial direction.

According to an advantageous embodiment of the present disclosure, it can be provided that the coupling elements are formed from a material that has a modulus of elasticity between 400 MPa and 46,000 MPa. The advantage of this embodiment is that it can provide a sufficient difference in stiffness to the magnets of the rotor in order to achieve particularly good coupling properties.

According to a further development of the present disclosure, it can also be provided that the coupling elements are formed from a material that has an elastic behavior during operation of the rotor. This can ensure that the contact surfaces of the coupling elements with the adjacent components can be relieved of load.

Furthermore, according to a likewise advantageous embodiment of the present disclosure, it can be provided that the coupling elements are rod-shaped and have an average thickness of at least 0.47 mm, preferably such as 0.5-10 mm, and particularly 0.5-5 mm in the circumferential direction. The advantageous effect of this embodiment is that it allows a minimum level of elasticity to be provided for decoupling.

According to a further embodiment of the present disclosure, it can be provided that the coupling elements have at least one connecting portion which deviates from a rod shape and which at least partly rests against one of the magnet elements. This makes it possible, in particular, to achieve the effect that radially acting force components between the coupling elements and the magnet elements can be better transmitted, for example by the magnet elements being form-fittingly encompassed by the corresponding connecting portions of the coupling elements.

Furthermore, the present disclosure can also be further developed in such a way that the coupling elements are substantially identical, which can also have a positive influence on the manufacturing costs due to the higher degree of uniformity.

In a likewise embodiment variant of the present disclosure, it can also be provided that the reinforcing braces are cuboidal, wherein the coupling elements each rest, at least partly, against a longitudinal surface of one of the reinforcing braces. This ensures that the load is uniformly transmitted from one of the reinforcing elements to one of the coupling elements without localized peaks.

The rotor can be produced by a method for producing a rotor for an axial flux machine, in particular for an axial flux machine within a powertrain of a motor vehicle, including the following steps:
providing a molding tool,
providing a plurality of reinforcing braces,
providing a plurality of magnet elements,
arranging the reinforcing braces and the magnet elements in the molding tool such that the reinforcing braces are positioned in the manner of spokes and a magnet element is arranged between each pair of circumferentially adjacent reinforcing braces, and wherein an air gap is provided on both sides of each of the reinforcing braces between one of the magnet elements and the corresponding reinforcing brace in the molding tool,
injection molding an inner ring and an outer ring using the molding tool such that the position of the reinforcing braces, the magnet elements, the inner ring, and the outer ring relative to each other is fixed, and
filling the air gaps on both sides of one of the reinforcing braces with a material that differs from the material of the inner ring and/or the outer ring and/or the magnet elements and/or the reinforcing braces such that a coupling element is formed between one of the magnet elements and the corresponding reinforcing brace.

Alternatively, a rotor can also be manufactured by a method for producing a rotor for an axial flux machine, in particular for an axial flux machine within a powertrain of a motor vehicle, including the following steps:
providing a molding tool,
providing a plurality of reinforcing braces,
providing a plurality of magnet elements,
providing a plurality of coupling elements with a material that differs from the material of an inner ring and/or an outer ring and/or the magnet elements and/or the reinforcing braces,
arranging the reinforcing braces and the magnet elements in the molding tool such that the reinforcing braces are positioned in the manner of spokes and a magnet element is arranged between each pair of circumferentially adjacent reinforcing braces, and wherein an air gap is provided on both sides of each of the reinforcing braces between one of the magnet elements and the corresponding reinforcing brace in the molding tool, injection molding the inner ring and the outer ring using the molding tool such that the position of the reinforcing braces, the magnet elements, the inner ring and the outer ring relative to each other is fixed, and inserting the coupling elements into the air gaps on both sides of one of the reinforcing braces.

### Bandage Element

According to a further embodiment of the present disclosure, the rotor can have an inner ring and an outer ring arranged coaxially thereto, wherein reinforcing braces extending in the radial direction between the inner ring and the outer ring are arranged in the manner of spokes, and a magnet element is arranged between each pair of circumferentially adjacent reinforcing braces, wherein an annular bandage element rests on the outer ring by way of a press fit such that a prestress is introduced into the rotor via the bandage element.

The bandage element can be manufactured, for example, using machining manufacturing methods. It is also conceivable for a bandage element to be completely or partially pressed, wound or laid. The bandage element can also be formed entirely or partially from injection molding or by way of casting. Furthermore, the bandage element can be formed by way of a wet winding process or a prepreg.

A bandage element has a circumferentially closed contour. In particular, the bandage element has a polygonal cross-sectional contour deviating from a circular path on its inner lateral surface facing the outer ring.

The auxiliary bandage of the bandage element has a polygonal cross-sectional contour deviating from a circular path on its inner lateral surface facing the outer ring. It is also contemplated for the auxiliary bandage of the bandage element to have a polygonal cross-sectional contour deviating from a circular path on its outer lateral surface facing away from the outer ring. The polygonal cross-sectional contour on the outer lateral surface substantially corresponds to the polygonal cross-sectional contour of the inner lateral surface of the auxiliary bandage. Similarly, the load bandage of the bandage element also has a polygonal cross-sectional contour deviating from a circular path on its inner lateral surface facing the auxiliary bandage.

A bandage element can be formed at least partly from a plastic. It is particularly contemplated for the plastic to be arranged in a circumferentially closed manner on the bandage element. Reinforced plastics, in particular fiber-reinforced plastics, are particularly contemplated. A fiber-reinforced plastics material can contain a short fiber, long fiber or continuous fiber or a mixture thereof. It is also conceivable for a bandage element to be made at least partly, such as continuously around, from a metallic material, in particular steel, and/or a ceramic.

A bandage element can be made of multiple parts with the same or partially different materials, wherein at least one material in the circumferential direction of the bandage have a modulus of elasticity greater than 48,000 MPa.

A bandage element can be formed directly onto the outer ring of the rotor in a primary forming method or can be attached to it subsequently, after the outer ring has been formed.

It is also conceivable for a bandage element to be machined, at least in some regions, both before and after being attached to the outer ring.

The bandage element can cover the outer ring of the rotor completely or in portions in the axial direction. In this case, an axial overlap that is as complete as possible is contemplated, as this enables particularly high and even application of pressure.

In particular, it can be advantageous for a plurality of bandage elements to be arranged axially in series on the rotor, which has the advantage that the bandage element can be constructed modularly and flexibly adapted to the length of a rotor.

It may also be advantageous to further develop the present disclosure in such a way that an annular auxiliary bandage rests on the outer ring. The coupling elements, together with the prestressed auxiliary bandage, allow the rotor disc to be subjected to circumferential pressure over its entire extent. This can ensure that the mean stresses of the stress amplitudes during operation are moved toward compression, which in turn has a positive effect on durability.

According to an advantageous embodiment of the present disclosure, it can be provided that the bandage element is designed in several parts with at least one annular auxiliary bandage resting on the outer ring and at least one annular load bandage resting on the auxiliary bandage. The advantage of this embodiment is that it allows the prestresses introduced into the rotor as well as the operating loads in the rotor and in the bandage to be controlled better and more precisely.

According to a further development of the present disclosure, it can also be provided that the material of the auxiliary bandage differs from the material of the load bandage, whereby the adjustability of the prestresses and the operating loads in the rotor and in the bandage can be further optimized. This means that, for example, magnets and radial braces at least partially determine the deflection points of the polygonal contour and thus increase the initial stiffness of the installed bandage.

Furthermore, according to a likewise advantageous embodiment of the present disclosure, it can be provided that at least one material of a multi-part bandage element, in particular the load bandage, has a modulus of elasticity of greater than 48,000 MPa in the circumferential direction of the bandage element. The advantageous effect of this embodiment is based on the fact that the bandage can absorb a relevant operating load due to the increased circumferential stiffness and thus reduce the stress on the rotor disc.

According to a further embodiment of the present disclosure, it can be provided that the prestress introduced into the rotor by the auxiliary bandage is greater than the prestress introduced by the load bandage. This makes it possible, particularly when using different materials, to specifically control the ratio of mean stress to stress amplitude in the bandages. This also allows the press-fit force to be optimized in relation to the tolerance situation.

Furthermore, the present disclosure can also be further developed in such a way that the load bandage rests on the auxiliary bandage in such a way that it does not introduce any prestress into the rotor. The advantage of this embodiment is that the mean stress in the bandage element is minimized.

In a likewise embodiment variant of the present disclosure, it can also be provided that the outer ring has a polygonal circumferential outer contour with a plurality of support points.

In this context, it is particularly contemplated for the support points of the polygonal contour to be determined by the load-introducing elements. This allows, for example, the magnets and radial braces to at least partially determine the deflection points of the polygonal contour and thereby increase the initial stiffness of the installed bandage.

If the centrifugal load of the magnets is introduced relatively discretely into a cylindrical or nearly cylindrical bandage element, such a bandage element can only provide low stiffness in the first load region. The first load region is a load region which is produced, for example, by centrifugal force or thermal expansion during operation of the rotor.

This in turn results in large movement amplitudes between the components with corresponding load amplitudes. If the bandage element is polygonalized along its load introduction and support points, it can exhibit advantageous stiffness and absorb corresponding loads particularly well.

It may also be advantageous to further develop the present disclosure in such a way that the bandage element is formed in one piece, in particular monolithically, with the outer ring. This has the advantage that the load-bearing bandage moves even closer to the load-generating components (magnets) and can therefore absorb the load more effectively.

Likewise, less stiff load transmission paths are reduced, resulting in a stiffer connection with less relative movement.

The rotor can be manufactured, for example, by a method including the following steps:
providing a rotor with an inner ring, wherein reinforcing braces extending radially outwardly from the inner ring are arranged in the rotor in the manner of spokes, and a magnet element is arranged between each pair of circumferentially adjacent reinforcing braces,
arranging an annular bandage element on the outer contour of the rotor by way of a press fit such that a prestress is introduced into the rotor via the bandage element, and
coupling the rotor to a rotor shaft.

The method can also be adapted to provide a rotor with an inner ring and an outer ring arranged coaxially thereto, wherein reinforcing braces extending in the radial direction between the inner ring and the outer ring are arranged in the manner of spokes, and a magnet element is arranged between each pair of circumferentially adjacent reinforcing braces.

Furthermore, in a further method step, the inner ring can be partially or completely removed from the rotor, for example by milling.

### Cover Disc

According to an advantageous embodiment of the present disclosure, it can be provided that at least one of the reinforcing braces and/or at least one of the magnet elements is connected to at least one cover disc which at least partly covers the rotor on a second end face of the rotor such that, during operation of the rotor, force can be transmitted from one of the reinforcing braces and/or at least one of the magnet elements to the at least one cover disc and/or vice versa. A further improvement in axial stiffness, distribution of stress peaks, acoustic properties and wear resistance can be achieved by at least partly covering the rotor with a cover disc on both of its end faces.

According to a further development of the present disclosure, it can also be provided that the cover disc on the first end face of the rotor and/or the cover disc on the second end face of the rotor are/is formed in the shape of an annular disc, which has proven to be particularly advantageous in terms of manufacturing costs and for reasons of operational reliability.

According to an advantageous embodiment of the present disclosure, it can be provided that the cover disc on the first end face of the rotor and/or the cover disc on the second end face of the rotor are/is formed in multiple parts. In particular, it is conceivable for the cover disc on the first end face of the rotor and/or the cover disc on the second end face of the rotor to be formed from disc elements stacked in layers. The stacked disc elements can be made of the same or different materials. In addition to a laminated, axially multi-part structure, it is also possible for the cover disc on the first end face of the rotor and/or the cover disc on the second end face of the rotor to be formed in multiple parts in the circumferential direction, for example as ring segments. In principle, it may also be advantageous for the cover disc on the first end face of the rotor and/or the cover disc on the second end face of the rotor to be designed in multiple parts in the radial direction, for example as annular discs arranged coaxially to each other.

It may further be contemplated for the cover disc on the first end face of the rotor and the cover disc on the second end face of the rotor each to include a ferromagnetic material in an overlap region and/or contact region with a magnet element.

It is also possible for the cover disc on the first end face of the rotor and the cover disc on the second end face of the rotor to partially cover, completely cover or even protrude from a respective end face.

In principle, the cover disc on the first end face of the rotor and/or the cover disc on the second end face of the rotor can be designed to be planar or contoured.

It may also be advantageous for the cover disc on the first end face of the rotor and/or the cover disc on the second end face of the rotor to have been surface-treated at least in portions, such as completely, on its surface facing away from the rotor and/or toward the rotor, thereby enabling further modification and adaptation of a cover disc to specific operating conditions of the rotor. In this context, it is also possible for the cover disc on the first end face of the rotor and the cover disc on the second end face of the rotor to be coated at least in portions, such as completely, on their surface facing away from the rotor and/or toward the rotor, for example with a lacquer.

In particular, it is also conceivable to design the cover disc on the first end face of the rotor and/or the cover disc on the second end face of the rotor in one piece with one or a plurality of other components of the rotor, for example with the outer ring and/or the bandage element. The cover disc on the first end face of the rotor and the cover disc on the second end face of the rotor can be attached directly to these components in the primary forming method or can also be attached subsequently.

The cover disc on the first end face of the rotor and/or the cover disc on the second end face of the rotor can, in particular, also be post-processed at least in portions after assembly on the rotor, in particular by way of machining methods.

Furthermore, according to a likewise advantageous embodiment of the present disclosure, it can be provided that the cover disc on the first end face of the rotor and/or the cover disc on the second end face of the rotor are/is formed from a plastic, in particular a fiber-reinforced and/or spherically reinforced plastic, non-magnetic steel, aluminum or a ceramic.

According to a further embodiment of the present disclosure, it can be provided that the cover disc on the first end face of the rotor and the cover disc on the second end face of the rotor project radially beyond the edge of the outer ring and a bandage element rests axially on the outer ring between the cover discs. This makes it possible, in particular, to achieve the effect that the cover discs can function as a receiving and guiding element for the bandage element during its assembly on the rotor as well as during operation of the rotor.

Furthermore, the present disclosure can also be further developed in such a way that the cover disc on the first end face of the rotor and/or the cover disc on the second end face of the rotor have fastening means, by way of which a torque can be transmitted from the rotor to a rotor flange, via which the torque can be introduced into a rotor shaft. In another embodiment of the present disclosure, it can also be provided that the fastening means include fastening openings arranged equidistantly on a circular path. In this way, a connection to a flange can be established, wherein screws which connect the flange to the rotor in torque-transmitting manner are then passed through the fastening openings.

It may also be advantageous to further develop the present disclosure in such a way that the cover disc on the first end face of the rotor and/or the cover disc on the second end face of the rotor have/has curvatures directed into the interior of the rotor. The advantage of these curvatures is in particular based on the localized transmission and relief of stresses in a cover disc.

According to a further embodiment of the subject matter of the present disclosure, it can be provided that the cover disc on the first end face of the rotor and/or the cover disc on the second end face of the rotor have/has an average axial extent which corresponds to between 1 and 80% of the axial extent of the magnet elements, which has proven to be particularly advantageous with regard to the desirable axial stiffness of a rotor.

Finally, the present disclosure can also be advantageously designed such that the cover disc on the first end face of the rotor and the cover disc on the second end face of the rotor are substantially identical, which can have a positive influence on manufacturing costs of the rotor due to the increased proportion of identical parts.

Furthermore, however, it is also possible for the cover disc on the first end face of the rotor and the cover disc on the second end face of the rotor to be made of different materials and/or to have a different geometry.

The cover disc on the first end face of the rotor and/or the cover disc on the second end face of the rotor can be specifically designed with regard to fire protection requirements and thus serve as a protective layer for the other components of the rotor. This means, for example, that the rotor can achieve an overall fire protection qualification without the individual components concealed beneath the cover discs having to directly meet such requirements.

### Inner Ring

According to a further embodiment of the present disclosure, the rotor for an axial flux machine, in particular for an axial flux machine within a powertrain of a motor vehicle, has a plurality of magnet elements which are arranged circumferentially distributed in the rotor, wherein the magnet elements are supported radially inwardly on an inner ring.

The inner ring can also be formed, for example, by a rotor shaft such that the magnet elements are supported radially inwardly on the rotor shaft, which acts as the inner ring.

Furthermore, it is possible for the magnet elements to be supported radially directly on the inner ring, at least in portions, or indirectly, at least in portions, for example via a contact rib formed radially between the inner ring and a magnet element. The contact rib can in particular be designed in one piece with the inner ring.

This has the advantage that the already partially assembled components of the rotor can be handled together via the inner ring during the manufacturing process.

In this case, the inner lateral surface of the inner ring can be put to repeated use as a receptacle for processing, for example by coupling a corresponding handling tool to the inner lateral surface of the inner ring.

Likewise, the inner ring can help to offer as little resistance as possible to circumferential prestressing of the rotor by means of an external prestress such that the prestress can generate circumferential residual stresses. The inner ring is thus an inner contour with low stiffness, which allows prestressing of the rotor in the circumferential direction, for example by a bandage element, or allows the development of circumferential residual stresses due to the prestress.

The inner ring also allows the individual tolerances of as many of the other components of the rotor as possible to be increased. The inner ring allows component tolerances to be “buffered.” For example, once the stiffness-determining components have been installed together in the rotor, but before the shaft is pressed in, it is possible for the inner diameter of the rotor or the inner ring to be adjusted to a common target dimension. The inner ring can therefore also define the inner diameter of the rotor very precisely.

The inner ring can be connected to other components of the rotor as a separate component or can be manufactured as a common component with them.

The inner ring can be formed by machining, pressing, injection molding or potting with filled or unfilled or reinforced or unreinforced polymer. It can be attached directly to the contact ribs and/or the reinforcing braces in the primary forming method or can be attached to them subsequently. In particular, it can also be cut from an extruded profile and connected to the rotor.

It is advantageous for the inner lateral surface of the inner ring to have a contour and/or a form-fitting means, by means of which the rotor can be received in circumferentially defined manner, for example in a handling tool.

According to an advantageous embodiment of the present disclosure, it can be provided that the rotor has an outer ring arranged coaxially to the inner ring, on which outer ring the magnet elements are supported radially outwardly.

According to a further development of the invention, it can also be provided that a plurality of contact ribs each extend radially outward from the inner ring and a plurality of the magnet elements are supported on the contact ribs. This makes it possible for the magnet elements to be fixed to the contact ribs in the radial and/or axial and/or circumferential direction. For this purpose, a contact rib on the contact surface to the magnet element can have a corresponding contour.

It is contemplated that a contact rib has a V-shaped contour in cross section, wherein the tip of the V-shaped contour is oriented radially inwards.

Furthermore, according to a likewise advantageous embodiment of the present disclosure, it can be provided that the number of contact ribs corresponds to the number of magnet elements. The advantageous effect of this embodiment is based on the fact that it allows a particularly precisely adjustable support of the magnet elements to be achieved.

According to a further embodiment of the present disclosure, it can be provided that a plurality of the contact ribs have an opening that passes axially through the respective contact rib. This allows a contact rib to be connected, for example, to a rotor flange in order to transmit torque from the rotor to the rotor flange via the contact ribs.

Furthermore, the present disclosure can also be further developed in such a way that a reinforcing brace extending in the radial direction between the inner ring and the outer ring is arranged between each pair of circumferentially adjacent contact ribs. The advantage of this embodiment is that the vibration behavior occurring during operation of the rotor can be better compensated by the components of the rotor subjected to centrifugal force.

In a likewise embodiment of the present disclosure, it can also be provided that the inner ring and the contact ribs are formed in one piece, in particular monolithically, with each other. This enables simplified production of the inner ring and the contact ribs. According to a further embodiment of the subject matter of the present disclosure, it can therefore also be provided that the inner ring is formed by way of an extrusion method.

It may also be advantageous to further develop the present disclosure in such a way that the inner ring is made of a material with a modulus of elasticity of less than 47 GPa. The advantage that can be achieved in this way is that the circumferential prestress builds up in the structure of the rotor disc and is less blocked by the ring.

It is further contemplated for the axial extent of the inner ring to correspond to at least 20% of the axial extent of the rotor.

Finally, the present disclosure can also be advantageously designed in such a way that the inner ring is removable from the rotor. The inner ring can therefore be removed, for example, before the rotor shaft is pressed in. It is therefore particularly contemplated for the contact ribs to remain in the rotor when the inner ring is removed.

In principle, it is of course also possible for the inner ring to serve as a kind of protective element for the radially outer components, for example for the end faces of the reinforcing braces toward the rotor shaft.

In this case, the inner ring can be formed with play relative to the rotor shaft. In particular, the inner ring does not transmit any torque to the rotor shaft via its inner lateral surface.

### Contact Ribs

The rotor for an axial flux machine, in particular for an axial flux machine within a powertrain of a motor vehicle, can include a plurality of magnet elements which are arranged circumferentially distributed in the rotor, wherein the magnet elements are supported radially inwardly on a plurality of contact ribs.

This provides the advantage that the torque generated at the magnet elements can be transmitted at least in part to a rotor shaft via the contact ribs.

For this purpose, the torque generated by the magnet elements is directed to the contact ribs, via which the torque can then be passed on to the rotor shaft, for example via an intermediate rotor flange. It is also possible to transmit some of the torque (radially) to the rotor shaft via the contact ribs directly or via an intermediate inner ring. This can be achieved, for example, by way of frictional engagement and/or form fit and/or material bond. Likewise, the contact ribs can transmit the torque to a component or a chain of components, which then transmit the torque to the shaft.

Furthermore, the contact ribs provide a supporting effect against axial tilting of the magnet elements during operation of the rotor. This also makes it possible for the magnet elements to be fixed to the contact ribs in the radial and/or axial and/or circumferential direction. For this purpose, a contact rib on the contact surface to the magnet element can have a corresponding contour.

Furthermore, the contact ribs within the rotor support the formation of a load path that can be predominantly prestressed under compressive stress from the rotor shaft to the magnet elements up to a bandage element. This allows the stress amplitudes in this path in particular to be minimized.

It is contemplated that a contact rib has a V-shaped contour in cross section, wherein the tip of the V-shaped contour is oriented radially inwards.

A contact rib can be designed in one part or multiple parts.

A contact rib may be designed such that it has a radial extent which corresponds to at least 48% of the radial extent between the radially outer edge of the rotor shaft and radially outer edge of the magnet elements.

A contact rib can be connected to other components of the rotor. A contact rib can be provided as a separate component in the rotor. It is also possible for a plurality of contact ribs, such as all the contact ribs, to be connected to each other, for example via an inner ring.

A contact rib can be produced by machining, pressing, injection molding or potting, with filled or unfilled or reinforced or unreinforced polymer. It can also be made of non-magnetic steel or ceramic.

A contact rib can be attached directly to a magnet element and/or the rotor shaft in a primary forming method or can be attached subsequently. Furthermore, it is possible for a contact rib to be connected to a single-or multi-layer interface on both the shaft side and the magnet side.

According to an advantageous embodiment of the present disclosure, it can be provided that the number of magnet elements corresponds to the number of contact ribs, which can contribute to a particularly good support of the magnet elements. In principle, however, it is also conceivable for a contact rib to be provided for contact with a plurality of magnet elements or for a plurality of contact ribs to be used per magnet.

According to a further embodiment of the present disclosure, it can also be provided that a plurality of the contact ribs have an opening which axially passes through the respective contact rib. This allows a contact rib to be connected, for example, to a rotor flange in order to transmit torque from the rotor to the rotor flange via the contact ribs.

Furthermore, according to a likewise advantageous embodiment of the present disclosure, it can be provided that at least one reinforcing brace extending in the radial direction is arranged between each pair of circumferentially adjacent contact ribs. The advantage of this embodiment is that the vibration behavior occurring during operation of the rotor can be better compensated by the components of the rotor subjected to centrifugal force.

According to a further embodiment of the present disclosure, it can be provided that a plurality of contact ribs each extend radially outward from an inner ring. In this way, the inner ring can help to offer as little resistance as possible to circumferential prestressing of the rotor by means of external prestressing such that the prestressing can generate circumferential residual stresses. The inner ring is thus an inner contour with low stiffness, which allows prestressing of the rotor in the circumferential direction, for example by a bandage element, or allows the development of circumferential residual stresses due to the prestress. Furthermore, the inner lateral surface of the inner ring can be put to repeated use as a receptacle for processing, for example by coupling a corresponding handling tool to the inner lateral surface of the inner ring.

Furthermore, the present disclosure can also be further developed in such a way that a plurality of contact ribs, such as all the contact ribs, are formed substantially identically. The resultant increased degree of uniformity of the rotor allows manufacturing costs in particular to be reduced.

In an embodiment of the present disclosure, it can also be provided that a plurality of the contact ribs are formed from a plastic, in particular a fiber-reinforced plastic, a non-magnetic steel or a ceramic.

It may also be advantageous to further develop the present disclosure in such a way that the contact ribs are formed from an extruded profile. This enables simplified production of the contact ribs and, if present, an inner ring.

According to a further embodiment of the subject matter of the present disclosure, it can be provided that the contact ribs are formed from punched and stacked laminations.

Finally, the present disclosure can also be advantageously designed such that at least one contact rib has a form-fitting means on its surface directed radially inwardly toward a rotor shaft, via which a torque-transmitting connection can be established between the rotor shaft and the contact rib. The advantage that results from this is, in particular, that a clear positioning of the rotor shaft and the contact rib relative to each other can be provided.

### Outer Ring

In particularly, the rotor for an axial flux machine, in particular for an axial flux machine within a powertrain of a motor vehicle, includes a plurality of magnet elements which are arranged circumferentially distributed in the rotor, wherein the magnet elements are supported radially outwardly on an outer ring.

This support can be direct or indirect. In the case of direct support, the magnet element rests at least partly against the outer ring. In the case of indirect support, a layer of material still remains, at least partly, between the magnet element and the outer ring.

This has the advantage that the usually very brittle magnet elements are better protected against mechanical influences and can uniformly transmit the loads caused by centrifugal forces during operation of the rotor. These forces caused by the magnet elements can thus be transmitted uniformly over a wide circumferential region of the outer ring to other components of the rotor, such as a bandage element.

It is therefore contemplated that the outer ring provides a “soft bedding” for the magnet elements in order to provide effective protection for the brittle material of the magnet elements from unwanted stress peaks. The outer ring can therefore conform to the magnet elements, which can be achieved in manufacturing terms, for example, by an injection molding process and/or via an interface layer such as an adhesive and/or via a material with a modulus of elasticity that is lower than the material of the magnet elements. This allows the force exerted by a magnet element to be dissipated over the largest possible contact area, which can reduce localized compressive stresses.

Furthermore, the outer ring can increase the axial stiffness of the rotor.

The outer ring can be produced by injection molding or potting, with filled or unfilled or reinforced or unreinforced polymer. It is also conceivable to form the outer ring from non-magnetic steel or ceramic.

According to an advantageous embodiment of the present disclosure, it can be provided that an annular bandage element rests on the outer ring by way of a press fit such that a prestress is introduced into the rotor via the bandage element.

This allows a bandage element to be protected from direct contact with the usually quite rough magnet elements. The outer ring thus separates the brittle, rough magnet elements from the bandage element, which is usually comparatively notch-sensitive.

Furthermore, the outer ring can provide the bandage element with a uniform bed on its outer lateral surface, which can simplify the pressing-on process of the bandage element and support a uniform load transmission into the bandage element. Furthermore, localized (over)stressing of the bandage element in the transverse direction can be reduced or completely avoided. In addition, the outer ring can also provide a uniform outer lateral surface over which a bandage element can be pressed. This surface can additionally be machined to an exact dimension before the press-fitting process, which allows the coverage of the press-fitted bandage element to be adjusted.

The outer ring therefore locally absorbs and concentrates the forces arising from the magnet elements and/or the reinforcing braces during operation of the rotor and passes these forces on to the bandage element uniformly over a larger region.

According to a further embodiment of the present disclosure, it can also be provided that the outer ring is circumferentially closed, which can be advantageous in particular from a manufacturing point of view but also with regard to the axial stiffness of the rotor.

Furthermore, according to a likewise advantageous embodiment of the present disclosure, it can be provided that the outer ring is formed from individual ring segments. In this case, in particular a ring segment of the outer ring and a magnet element can form a structural unit, which is then formed into a ring by circumferentially arranging a plurality of these structural units.

The outer ring can therefore be formed as a closed ring or from ring segments which are arranged to form a ring. The outer ring can be rolled from a punched strip or cut from an extruded profile. Furthermore, it is conceivable for an outer ring to be punched out of a plate as a longitudinal structure and fanned out.

According to a further embodiment of the present disclosure, it can be provided that the outer ring includes a plurality of pockets, each of which has a contact surface extending in the circumferential direction for a magnet element and, on both sides of the magnet element in the circumferential direction, each has a coupling portion extending radially inward from the outer ring. This can achieve the effect that the guidance and positioning of the magnet elements in the circumferential direction can be improved. Furthermore, the pockets also facilitate the production of the rotor, since the magnet elements can be positioned in a predefined position relative to the outer ring via the pockets, for example before an injection molding or potting process.

Furthermore, the present disclosure can also be further developed in such a way that at least one reinforcing brace is arranged between each pair of circumferentially adjacent magnet elements, which reinforcing brace extends in the radial direction toward the outer ring, whereby load paths can also be transmitted in a defined manner to the outer ring through the reinforcing braces.

In a likewise embodiment of the present disclosure, it can also be provided that a plurality of reinforcing braces are each supported in the radial direction on the outer ring such that the reinforcing braces can be prevented from tilting. This also allows the forces of the reinforcing braces to be transmitted particularly uniformly to the bandage element. This contributes positively to the overall axial stiffness of the rotor disc.

It may also be advantageous to further develop the present disclosure in such a way that at least one reinforcing brace is supported in the radial direction on a coupling portion of the outer ring, which can further improve the force transmission between the reinforcing braces and the outer ring.

It would also be possible for a plurality of reinforcing braces to be supported in the radial direction on a coupling portion of the outer ring.

According to a further embodiment of the subject matter of the present disclosure, it can be provided that the outer ring is formed by way of an extrusion method, which is particularly advantageous in terms of production technology.

Finally, the present disclosure can also be advantageously designed such that the outer ring has a polygonal circumferential outer contour with a plurality of support points. It has been shown that if the outer ring is polygonalized along its load introduction and support points, it has an advantageous stiffness and can absorb corresponding loads particularly well.

In this context, it is particularly contemplated for the support points of the polygonal contour to be determined by the load-introducing elements. As a result, the shape during loading is already anticipated in the unloaded structure, which leads to an increased initial stiffness.

### Reinforcing Braces

The rotor for an axial flux machine, in particular for an axial flux machine within a powertrain of a motor vehicle, includes an inner ring and an outer ring arranged coaxially thereto, and magnet elements arranged between the inner ring and the outer ring, wherein reinforcing braces extending in the radial direction are arranged in the manner of spokes between the inner ring and the outer ring, and one of the magnet elements is arranged on each side of a reinforcing brace in the circumferential direction and is operatively connected to a reinforcing brace in such a way that a force component caused by centrifugal force acting on the magnet elements during operation of the rotor can be transmitted from a magnet element to a reinforcing brace and/or vice versa, wherein at least one of the reinforcing braces and/or at least one of the magnet elements is connected to at least one cover disc which at least in part covers the rotor on a first end face of the rotor such that, during operation of the rotor force can be transmitted from one of the reinforcing braces and/or at least one of the magnet elements to the at least one cover disc and/or vice versa.

On the one hand, this can increase the axial stiffness of the rotor. Furthermore, the rotor according to the present disclosure makes it possible to introduce the centrifugal loads of the magnet elements more uniformly radially outward, for example into the outer ring and/or into a bandage element.

The inner ring can also be formed, for example, by a rotor shaft such that the magnet elements are supported radially inwardly on the rotor shaft, which acts as the inner ring.

Furthermore, the reinforcing braces can be in partial or complete direct contact with the bandage.

Furthermore, the cover disc allows the provision of a uniform contact surface for contacting and absorbing operating forces, for example through a flange. The flange can advantageously be connected to the cover disc via a tightly tolerated contact surface in order to allow the operating forces that occur to be uniformly and safely absorbed. For example, the cover disc can also distribute stress peaks caused by nonuniformities in the rotor over larger regions and thus reduce them.

Furthermore, the cover disc can have advantageous effects on the acoustics and air friction during operation of the rotor due to a uniform, in particular planar, surface. In the event of contact between the rotor and the stator, the cover disc can also minimize the effects of contact and wear of the rotor's functional components. The cover disc can also serve as a type of wear element for contact between the rotor and the stator. On the one hand, this serves to protect the internal structure, and on the other hand, the cover disc can be treated locally to minimize the effects of rubbing, for example by means of a sliding layer for lower energy input, a localized wear-resistant layer, and/or a sensor in the region of a contact point to detect the onset of contact.

Reinforcing braces extending in the radial direction between the inner ring and the outer ring are arranged in the manner of spokes, with a magnet element being arranged between each pair of circumferentially adjacent reinforcing braces.

According to an advantageous embodiment of the present disclosure, it can be provided that a coupling element is arranged on both sides of each of the reinforcing braces in the circumferential direction between one of the magnet elements and the corresponding reinforcing brace, wherein the coupling elements are formed from a material that differs from the inner ring and/or the outer ring and/or the magnet elements and/or the reinforcing braces.

According to a further development of the present disclosure, it can be provided that at least one of the reinforcing braces is formed in multiple parts. It can also be provided that a plurality of the reinforcing braces are made of multiple parts. Furthermore, it is possible for all the reinforcing braces to be formed in multiple parts.

Furthermore, according to a likewise advantageous embodiment of the present disclosure, it can be provided that at least one of the reinforcing braces is formed integrally with the inner ring and/or the outer ring. It may further be contemplated for a plurality of the reinforcing braces to be formed integrally with the inner ring and/or the outer ring. All the reinforcing braces may be formed integrally with the inner ring and/or the outer ring.

The reinforcing braces can be inserted directly into the rotor in a primary forming method or arranged subsequently therein. The reinforcing braces can be machined again, at least in parts, both before and after being installed in the rotor.

According to a further embodiment of the present disclosure, it can be provided that at least one material of at least one reinforcing brace in the radial extent of the reinforcing brace has a modulus of elasticity of greater than 6000 MPa. It may also be contemplated for at least one material of a plurality of reinforcing braces in the radial extent of the reinforcing braces to have a modulus of elasticity of greater than 6000 MPa.

Furthermore, it is also contemplated for at least one material of all the reinforcing braces in the radial extent of the reinforcing brace to have a modulus of elasticity of greater than 6000 MPa.

Furthermore, the present disclosure can also be further developed in such a way that at least one of the reinforcing braces is formed from a plastic, in particular a fiber-reinforced plastic, non-magnetic steel, aluminum or a ceramic.

It is particularly contemplated for the material of one of the reinforcing braces to differ from the material of the coupling elements and/or the inner ring and/or the outer ring and/or the magnet elements The reinforcing braces can be produced by machining, pressing, winding, injection molding, potting, wet winding or prepreg with filled or unfilled or reinforced or unreinforced polymer. The reinforcements can be spherical, short fiber, long fiber or continuous fiber or a mixture thereof.

In a likewise embodiment of the present disclosure, it can also be provided that the reinforcing braces, the magnet elements and/or the inner ring have a counteracting prestress to a load bandage and/or an auxiliary bandage at the operating point of the rotor.

It can also be advantageous to further develop the present disclosure in that at least one of the reinforcing braces is cuboidal. A plurality of the reinforcing braces are formed to be cuboidal. Further, all the reinforcing braces may be formed to be cuboidal.

According to a further embodiment of the subject matter of the present disclosure, it can be provided that a plurality of the reinforcing braces, such as all the reinforcing braces, are substantially identical, which is advantageous in particular with regard to manufacturing costs.

Finally, the present disclosure can also be advantageously designed such that at least one of the reinforcing braces is connected on one of its axial surfaces to a cover disc which at least partly covers the rotor on one end face of the rotor. In this context, it may also be contemplated for a plurality of the reinforcing braces each to be connected on one of their axial surfaces to a cover disc which, on one end face of the rotor, at least partly covers the rotor. It is also highly contemplated that all reinforcing braces are each connected on one of their axial surfaces to a cover disc which, on one end face of the rotor, at least partly covers the rotor.

The present disclosure will be explained below in more detail with reference to figures without limiting the general idea of the present disclosure.

### BRIEF DESCRIPTION OF THE DRAWINGS

In the figures:

FIG. 1 shows a perspective view of a rotor for an axial flux machine,

FIG. 2 shows an exploded view of a rotor for an axial flux machine,

FIG. 3 shows a cross-sectional view of a rotor of an axial flux machine,

FIG. 4 shows a cross-sectional detail view of the rotor shown in FIG. 3,

FIG. 5 shows isolated reinforcing braces, an outer ring and a bandage element in a perspective view,

FIG. 6 shows an outer ring in a cross-sectional view,

FIG. 7 shows a detailed view of the contact surface of the outer ring in a cross-sectional view,

FIG. 8 shows a detailed view of a coupling element in the rotor in a cross-sectional view,

FIG. 9 shows a rotor in three different manufacturing states, each in a cross-sectional view,

FIG. 10 shows a first embodiment of a magnet element in a cross-sectional view,

FIG. 11 shows a first embodiment of a magnet element in a perspective view,

FIG. 12 shows a second embodiment of a magnet element in a perspective view,

FIG. 13 shows a third embodiment of a magnet element in a perspective view,

FIG. 14 shows a fourth embodiment of a magnet element in a perspective view,

FIG. 15 shows two embodiments of a bandage element, each in a perspective sectional view,

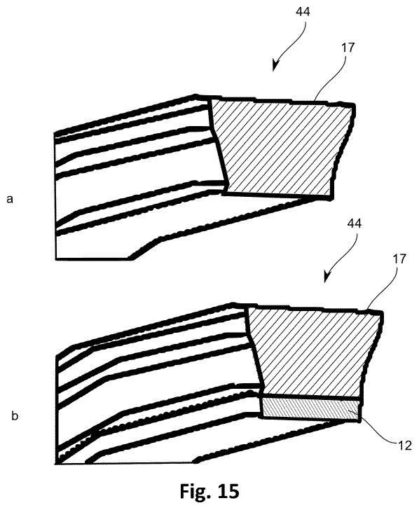

FIG. 16 shows a rotor in a perspective axial sectional view,

FIG. 17 shows a rotor with cover disc in an axial sectional view,

FIG. 18 shows an isolated inner ring with contact ribs and magnet elements in a cross-sectional view,

FIG. 19 shows a rotor without an inner ring in a cross-sectional view,

FIG. 20 shows two embodiments of an axial flux machine, each in a schematic axial sectional view, and

FIG. 21 shows a motor vehicle with an axial flux machine in a schematic view.

### DETAILED DESCRIPTION

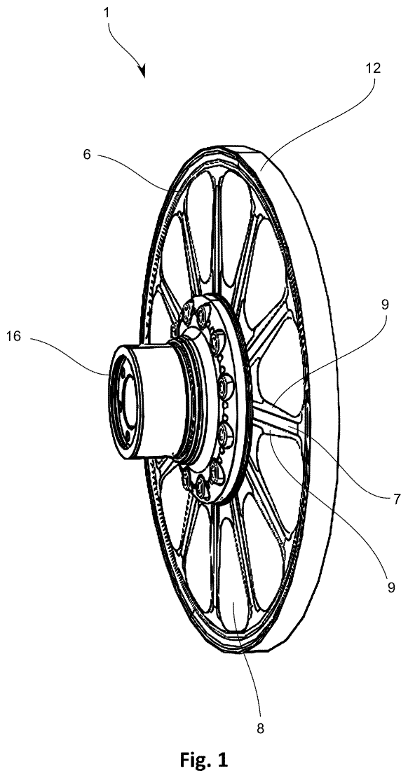

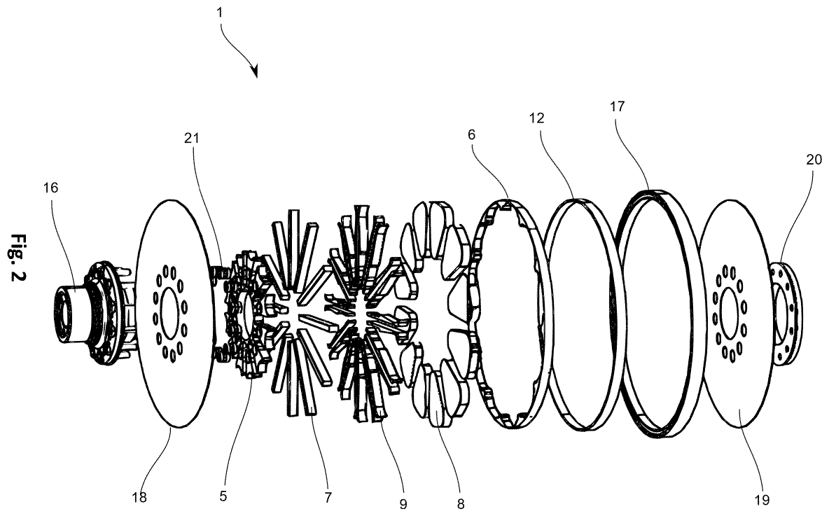

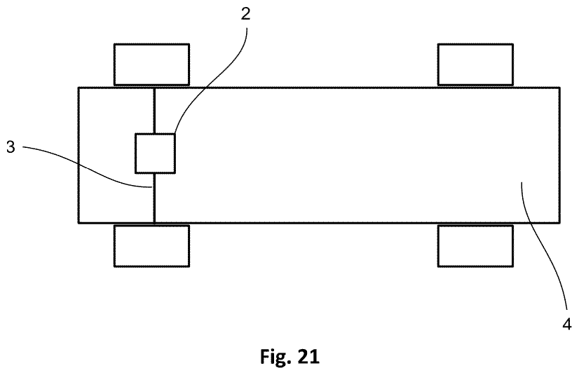

FIG. 1 and FIG. 2 show a rotor 1 for an axial flux machine 2, in particular for an axial flux machine 2 within a powertrain 3 of a motor vehicle 4, as also depicted in FIG. 21.

The rotor 1 includes an inner ring 5 and an outer ring 6 arranged coaxially thereto, wherein cross-sectionally rectangular rod-like reinforcing braces 7 are arranged in the manner of spokes extending in the radial direction between the inner ring 5 and the outer ring 6. A magnet element 8 is arranged between each pair of circumferentially adjacent reinforcing braces 7.

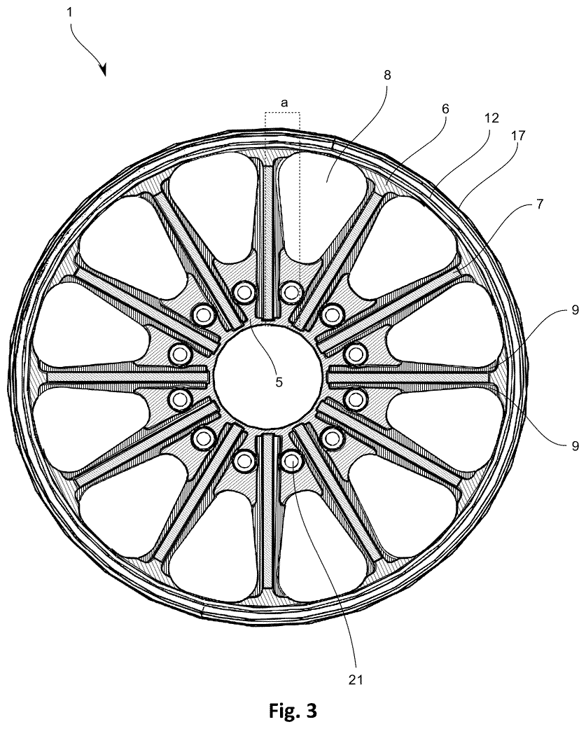

As can be clearly seen from FIG. 3, a coupling element 9 is arranged on both sides of each of the reinforcing braces 7 in the circumferential direction between one of the magnet elements 8 and the corresponding reinforcing brace 7. The coupling elements 9 are substantially identical.

The coupling elements 9 are formed from a material that differs from the inner ring 5 and/or the outer ring 6 and/or the magnet elements 8 and/or the reinforcing braces 7 and/or the contact ribs 60.

The magnet elements 8 are received radially on the outside by a closed outer ring 6. The annular auxiliary bandage 12 with the annular load bandage 17 is connected thereto. Radially inwardly, the magnet elements 8 rest on the inner ring 5 via the contact ribs 60, which inner ring is coupled to the rotor shaft 23 via the flange 16. A cover disc 18, 19 is attached axially on both sides. The flange 16 receives the inner ring 5 or the contact ribs 60 and is connected to the flange ring 20 with screws. The compression limiters 21 support the inner ring 5 and act as screw support elements.

The coupling element 9 serves to compensate for relative displacements between the magnet elements 8 and further components and, at the same time, to reduce the normal tensile stress on the coupling elements 9. At the same time, the coupling elements 9 are used to transmit centrifugal forces of the magnet elements 8 to the reinforcing braces 7 and thus, among other things, to relieve the cover layers. The coupling elements 9 bind the cover layers, i.e., the cover discs 18, 19, axially to the rotor 1 in order to maintain a stable air gap between the rotor 1 and the stator 22. Furthermore, the coupling elements 9, together with the prestressed bandage (before the shaft is pressed in), allow the rotor 1 to be subjected to circumferential pressure. For this purpose, an annular auxiliary bandage 12 is applied to the outer ring 6. The elasticity of the coupling element 9 defines the circumferential stiffness of the rotor 1 or adjusts it in targeted manner to the desired level.

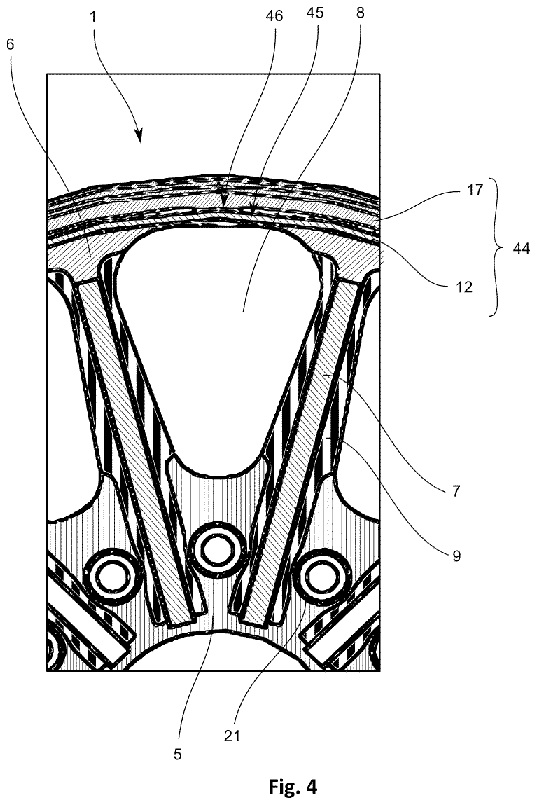

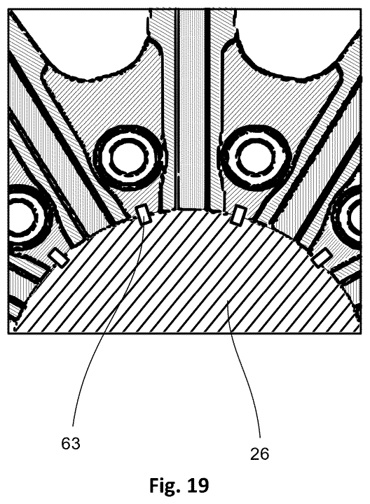

FIGS. 3-4 show the rotor 1 with an inner ring 5 on which the reinforcing braces are radially supported. However, if this rotor 1 is mounted on a rotor shaft 26 in a rotationally fixed manner, the inner ring 5 from FIGS. 3-4 may also have been removed, for example by milling, before mounting on the rotor shaft 26 such that, in the mounted state, the inner ring 5 is formed by the outer lateral surface of the rotor shaft 26. This is shown in FIG. 19, where the reinforcing braces 7 are then supported radially directly on the rotor shaft 26.

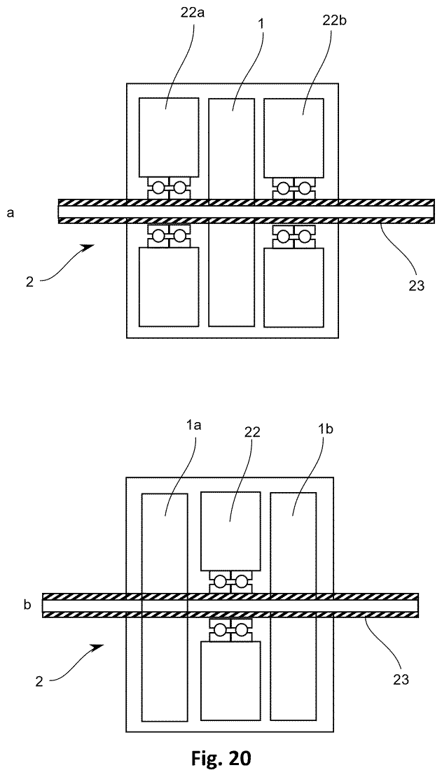

The rotor 1 can be used in an axial flux machine 2 in an H-configuration, as shown in FIG. 20a, or in an I-configuration, which is shown in FIG. 20b.

FIG. 4 shows a detailed view of the rotor 1 known from FIG. 3.

Here, the inner ring 5 and the outer ring 6 arranged coaxially thereto can also be clearly seen, wherein reinforcing braces 7, extending in the radial direction between the inner ring 5 and the outer ring 6, are arranged in the manner of spokes, and a magnet element 8 is arranged between each pair of circumferentially adjacent reinforcing braces 7.

An annular bandage element 44 rests against the outer ring 6 by way of a press fit such that a prestress is introduced into the rotor 1 via the bandage element 44. The bandage element 44 can cover the outer ring 6 of the rotor 1 completely or in portions in the axial direction. The bandage element 44 is designed in multiple parts, with at least one annular auxiliary bandage 12 resting on the outer ring 6 and at least one annular load bandage 17 resting on the auxiliary bandage 12. In principle, it would also be possible to design the bandage element 44 as a single part. Furthermore, it is also possible that only the auxiliary bandage 12 is applied via an interference fit, and the load bandage 17 is positioned thereon without any load. Of course, the auxiliary bandage 12 and load bandage 17 can also be provided with an interference fit.

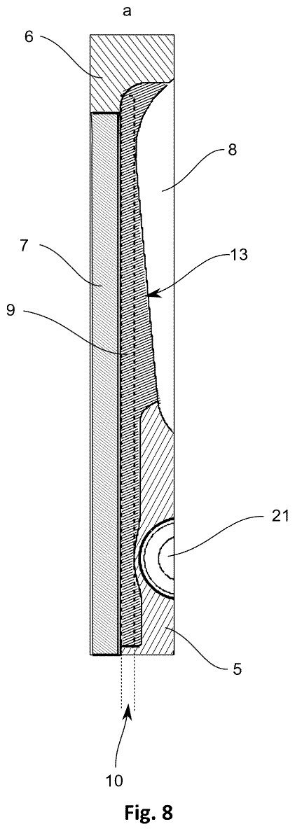

The coupling elements 9 of the rotor 1 are explained in more detail below with reference to FIG. 8. The coupling element 9 serves primarily to compensate for relative displacements between the magnet elements 8 and further components and, at the same time, to reduce the normal tensile stress on the coupling elements 9. At the same time, the coupling elements 9 are used to transmit centrifugal forces of the magnet elements 8 to the reinforcing braces 7 and thus, among other things, to relieve the cover layers. The coupling elements 9 bind the cover layers, i.e., the cover discs 18, 19, axially to the rotor 1 in order to maintain a stable air gap between the rotor 1 and the stator 22. Furthermore, the coupling elements 9, together with the prestressed bandage (before the shaft is pressed in), allow the rotor 1 to be subjected to circumferential pressure. For this purpose, an annular auxiliary bandage 12 is applied to the outer ring 6. The elasticity of the coupling element 9 defines the circumferential stiffness of the rotor 1 or adjusts it in targeted manner to the desired level.

The coupling elements 9 are formed from a material that has a modulus of elasticity between 400 MPa and 46,000 MPa and exhibits an elastic behavior during operation of the rotor 1.

As shown in FIG. 8, the coupling elements 9 are rod-shaped and have an average thickness 10 in the circumferential direction of at least 0.47 mm, such as 0.5-10 mm, and particularly 0.5-5 mm. Furthermore, the coupling elements 9 have, in the region of the magnet elements 8, a connecting portion 13 which deviates from a rod shape and which rests in portions on one of the magnet elements 8. The reinforcing braces 7 are cuboidal, wherein the coupling elements 9 each rest at least partly against a longitudinal surface 11 of one of the reinforcing braces 7.

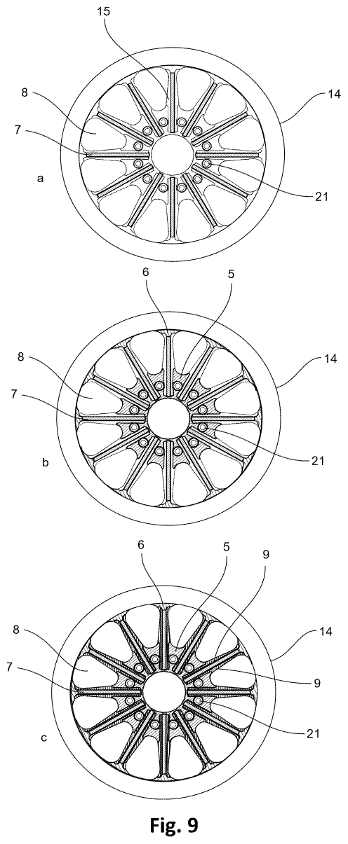

FIG. 9 shows one possible manufacturing method for the rotor 1. The rotor 1 is manufactured by equipping a tool at least with the magnet elements 8, to which the compression limiter 21 and reinforcing braces 7, among other things, can be added. Subsequently, in one or a plurality of steps, the outer ring 6 and the contact ribs 60, including the possibly only temporarily present inner ring 5, are overmolded, pressed on or connected. The cover discs 18, 19 can then be applied and any remaining filling regions can be filled with a filling compound. The rotor 1 can be circumferentially prestressed via an auxiliary bandage 12 before the rotor shaft 23 is pressed in. A load bandage 17 radially outside the auxiliary bandage 12 can also optionally be applied with prestress. The central bore and shaft receptacle are then created by removing most or all of the inner ring 5. Pressing on the rotor shaft 23 with axial fixation of the flange 16 constitutes the interface to the rotor 1. The rotor 1 is balanced in a balancing process on the flange 16, the flange disc 20, the outer ring 6 or on the coupling elements 9.

A first method for producing a rotor 1 for an axial flux machine 2 can thus, as explained again, include the following steps: First, a molding tool 14, a plurality of reinforcing braces 7, and a plurality of magnet elements 8 are provided.

Then, the reinforcing braces 7 and the magnet elements 8 are arranged in the molding tool 14 such that the reinforcing braces 7 are positioned in the manner of spokes and a magnet element 8 is arranged between each pair of circumferentially adjacent reinforcing braces 7, and wherein an air gap 15 is provided on both sides of each of the reinforcing braces 7 between one of the magnet elements 8 and the corresponding reinforcing brace 7 in the molding tool 14. This manufacturing state can be seen in FIG. 9a.

Subsequently, injection molding is carried out to form an inner ring 5 and an outer ring 6 using the molding tool 14 such that the position of the reinforcing braces 7, the magnet elements 8, the inner ring 5 and the outer ring 6 relative to each other is fixed, which is shown in FIG. 9b.

Now the air gaps 15 on both sides of one of the reinforcing braces 7 are filled with a material that differs from the material of the inner ring 5 and/or the outer ring 6 and/or the magnet elements 8 and/or the reinforcing braces 7 such that a coupling element 9 is formed between one of the magnet elements 8 and the corresponding reinforcing brace 7. Filling can be carried out by way of an injection molding process in the molding tool 14 or a casting process. However, filling can also only take place after one or both cover discs 18, 19 have been applied.

Alternatively, it is possible to first provide a molding tool 14, a plurality of reinforcing braces 7, a plurality of magnet elements 8, and a plurality of coupling elements 9 with a material that differs from the material of an inner ring 5 and/or an outer ring 6 and/or the magnet elements 8 and/or the reinforcing braces 7.

Thus, first, the reinforcing braces 7 and the magnet elements 8 are arranged in the molding tool such that the reinforcing braces 7 are positioned in the manner of spokes and a magnet element 8 is arranged between each pair of circumferentially adjacent reinforcing braces 7, and wherein an air gap 15 is provided on both sides of each of the reinforcing braces 7 between one of the magnet elements 8 and the corresponding reinforcing brace 7 in the molding tool 14.

Then the inner ring 5 and the outer ring 6 are injection molded using the molding tool 14 such that the position of the reinforcing braces 7, the magnet elements 8, the inner ring 5 and the outer ring 6 relative to each other is fixed. Finally, the coupling elements 9 are inserted into the air gaps 15 on both sides of one of the reinforcing braces 7.

FIG. 9c then shows the rotor 1 with the coupling elements 9 inserted.

The rotor 1 can be used in an axial flux machine 2 in an H-configuration, as shown in FIG. 9a, or in an I-configuration, which is shown in FIG. 9b.

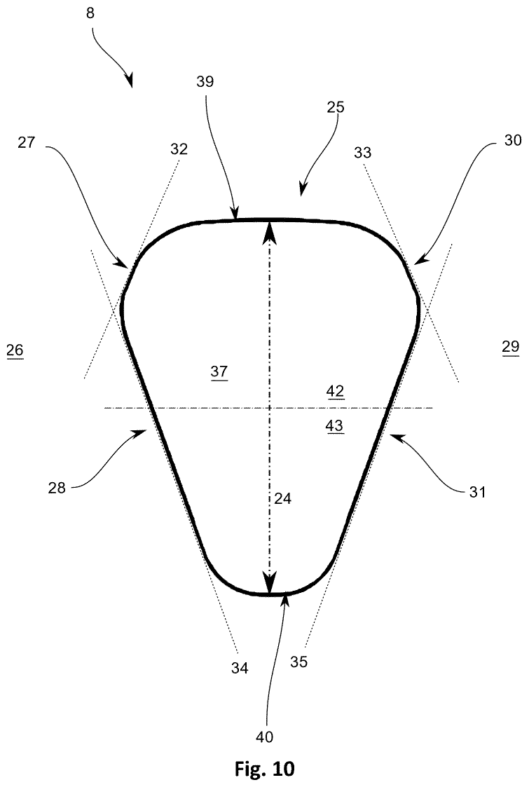

FIG. 10 shows a magnet element 8 for a rotor 1 of an axial flux machine 2, wherein the magnet element 8 has a longitudinal extent 24 and a continuous circumferential contour 25.

On a first side 26, which faces a first direction of rotation of the rotor 1 when the magnet element 8 is installed in the rotor 1, a first planar surface portion 27 extending in the longitudinal direction and a second planar surface portion 28 extending in the longitudinal direction are formed. When the magnet element 8 is installed in the rotor 1, the first surface portion 27 is positioned radially above the second surface portion 28.

In the embodiment shown in FIG. 10, the magnet element 8 is formed mirror-symmetrically with respect to its longitudinal extent 24. Thus, on a second side 29, which faces a second direction of rotation of the rotor 1 when the magnet element 8 is installed in the rotor 1, a third planar surface portion 30 extending in the longitudinal direction and a fourth planar surface portion 31 extending in the longitudinal direction are formed, wherein, when the magnet element 8 is installed in the rotor 1, the third surface portion 30 is positioned radially above the fourth surface portion 31.

The surface portions 27, 28, 30, 31 are arranged and shaped such that a first plane 32 extending through the first surface portion 27 and a third plane 33 extending through the third surface portion 30 intersect radially above the magnet element 8 in the direction of the longitudinal extent 24 when the magnet element 8 is installed in the rotor 1, and a second plane 34 extending through the second surface portion 28 and a fourth plane 35 extending through the fourth surface portion 31 intersect radially below the magnet element 8 in the direction of the longitudinal extent 24 when the magnet element 8 is installed in the rotor 1.

The first planar surface portion 27 and the third planar surface portion 30 have a length in the circumferential direction of the magnet element 8 of at least 2 mm and at most 48 mm. The first planar surface portion 27 and the third planar surface portion 30 can serve for sealing, radial positioning in the tool during the manufacture of the rotor 1 and as a reference surface for magnetic sorting (center of mass relative to geometric shape).

FIG. 10 further shows that the circumferential contour 25 has a fifth surface portion 39 which, when installed in the rotor 1, is oriented radially outwardly and connects the first surface portion 27 to the third surface portion 30, wherein the fifth surface portion 39 has a circular arc-shaped contour with an axis of rotation extending coaxially to an axis of rotation of the rotor 1. The magnet element 8 therefore has a contour on its radially outer surface which substantially follows a circular arc with a center that is concentric with the axis of rotation of the rotor 1. As a result of this contour, the (centrifugal) loads generated by the magnet element 8 are uniformly transmitted to the radially outer component regions (e.g., the auxiliary bandage 12 or the load bandage 17). In addition, the magnet element 8 supports these outer regions uniformly.

As is also apparent from FIG. 10, the magnet element 8 has an upper region 42 and a lower region 43, wherein the upper region 42 extends above half of the longitudinal extent 24 of the magnet element 8 and the lower region 43 extends below half of the longitudinal extent 24 of the magnet element 8. The first surface portion 27 and the third surface portion 30 extend exclusively within the upper region 42 of the magnet element 8.

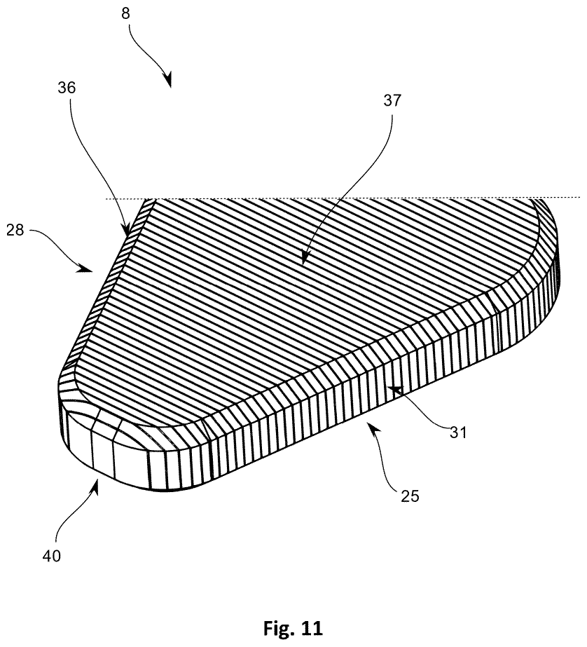

From the embodiment shown in FIG. 11, it can be seen that the circumferential contour 25 can have a chamfer 36 which is formed at the transition between the circumferential contour 25 and an axial surface 37. In this example, the chamfer 36 runs circumferentially around the circumferential contour 25. The chamfer 36 can contribute in the region of the circumferential contour 25 to improving the adhesion of a magnet element 8 to the adjacent components, for example in order to allow a thicker and thus more elastic adhesive layer or connecting layer to the magnet element 8. The chamfer 36 can vary in its contour along its course around the circumference of the magnet.

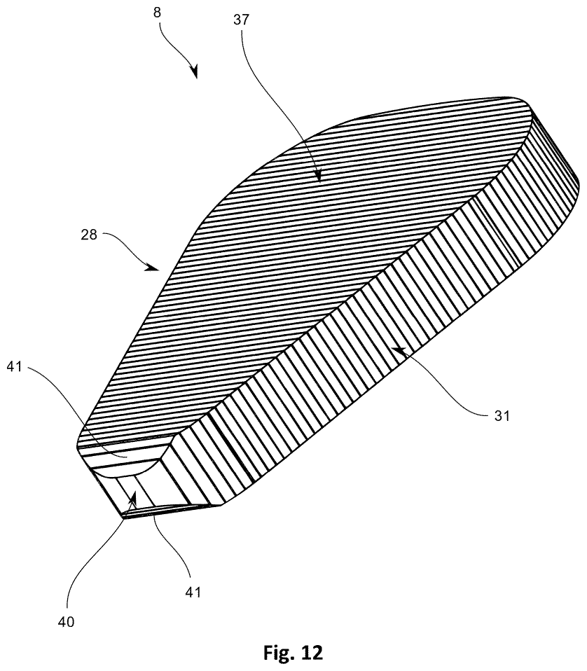

FIG. 12 shows an embodiment of a magnet element 8 in which the circumferential contour 25 has a sixth surface portion 40 which, once installed in the rotor 1, is oriented radially inwardly and connects the second surface portion 28 to the fourth surface portion 31, wherein the sixth surface portion 40 has a chamfer 41 which is formed at the transition between the sixth surface portion 28 and an axial surface 37. This defines a wedge-like contour on the sixth surface portion 40, which can simplify the connection of the magnet element 8 to, for example, an inner ring 5 of the rotor 1.

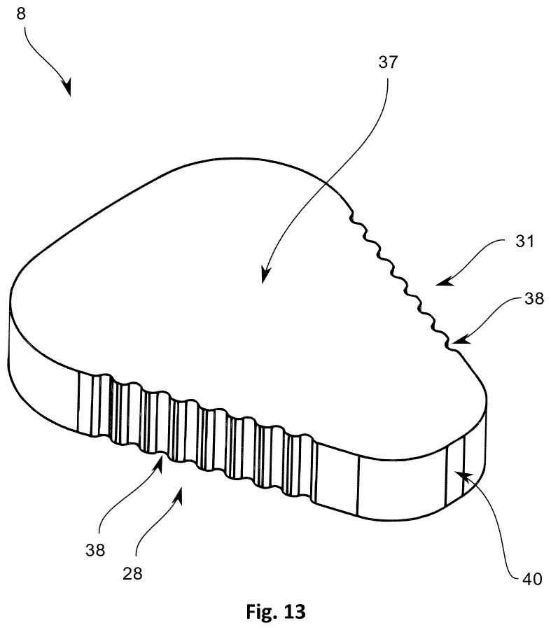

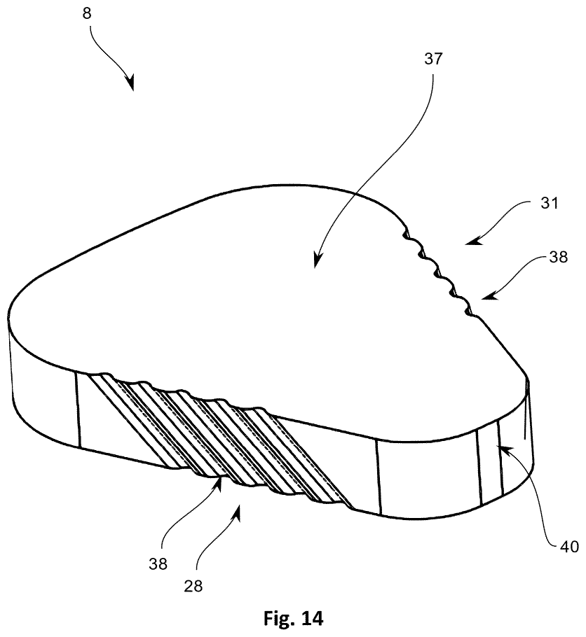

As shown in FIGS. 13-14, the second planar surface portion 28 and the fourth planar surface portion 31 can each have structures 38 that protrude out from or project into the respective planar surface, at least in portions. These structures 38 are designed as profiling, which provides a type of undercut in the radial direction for a form fit in the adhesive bond or connection. This profiling must is at least be designed in such a way that it results in an increased surface area for the connection and optimized support of operational loads.

As can be seen, for example, in FIG. 4, an annular bandage element 44 can rest on the outer ring 6 of the rotor 1 by way of a press fit such that a prestress is introduced into the rotor 1 via the bandage element 44. In this embodiment shown, the bandage element 44 is designed in multiple parts, with at least one annular auxiliary bandage 12 resting on the outer ring 6 and at least one annular load bandage 17 resting on the auxiliary bandage 12, wherein the material of the auxiliary bandage 12 differs from the material of the load bandage 17.

At least one material of the multi-part bandage element 44, in particular the load bandage 17, has a modulus of elasticity of greater than 48,000 MPa in the circumferential direction of the bandage element 44. In this case, the prestress introduced into the rotor 1 by the auxiliary bandage 12 is greater than the prestress introduced by the load bandage 17. The bandage element 44 can even be configured such that the load bandage 17 rests on the auxiliary bandage 12 in such a way that it does not introduce any prestress into the rotor 1.

The outer ring 6 has a polygonal circumferential outer contour 45 with a plurality of support points 46.

The bandage element 44 can be attached to the rotor 1, for example, as follows: First, a rotor 1 is provided with an inner ring 5 and an outer ring 6 arranged coaxially thereto, wherein reinforcing braces 7, extending in the radial direction between the inner ring 5 and the outer ring 6, are arranged in the manner of spokes, and a magnet element 8 is arranged between each pair of circumferentially adjacent reinforcing braces 7. Then, an annular bandage element 44 is arranged on the outer ring 6 by way of a press fit such that a prestress is introduced into the rotor 1 via the bandage element 44. Finally, the rotor 1 is coupled to a rotor shaft 23.

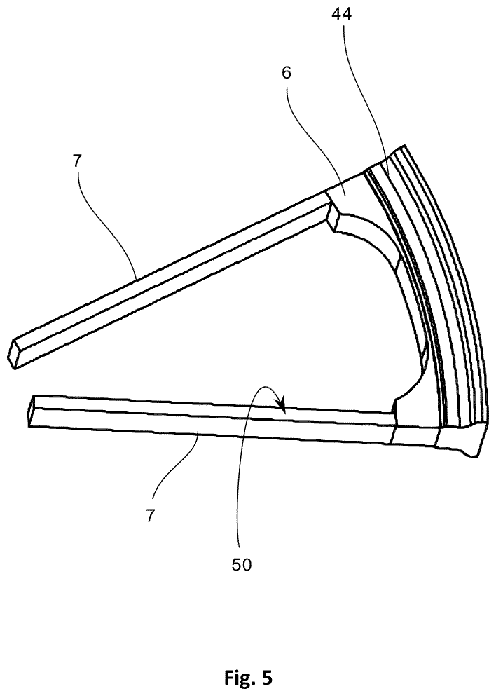

The reinforcing braces 7 are explained in more detail below with reference to FIG. 4 and FIG. 5. FIG. 4 shows the rotor 1 including an inner ring 5 and an outer ring 6 arranged coaxially thereto, and magnet elements 8 arranged between the inner ring 5 and the outer ring 6, wherein reinforcing braces 7 are arranged in the manner of spokes in the radial direction between the inner ring 5 and the outer ring 6.

One of the magnet elements 8 is arranged on both sides of a reinforcing brace 7 in the circumferential direction and is operatively connected to a reinforcing brace 7 in such a way that a force component caused by centrifugal force acting on the magnet elements 8 during operation of the rotor 1 can be transmitted from a magnet element 8 to a reinforcing brace 7 and/or vice versa.

From FIG. 4, it can also be seen that a coupling element 9 is arranged on both sides of one of the reinforcing braces 7 in the circumferential direction between one of the magnet elements 8 and the corresponding reinforcing brace 7, wherein the coupling elements 9 are formed from a material that differs from the inner ring 5 and/or the outer ring 6 and/or the magnet elements 8 and/or the reinforcing braces 7. The material of a reinforcing brace 7 has a modulus of elasticity of greater than 6000 MPa in the radial extent of the reinforcing brace 7.

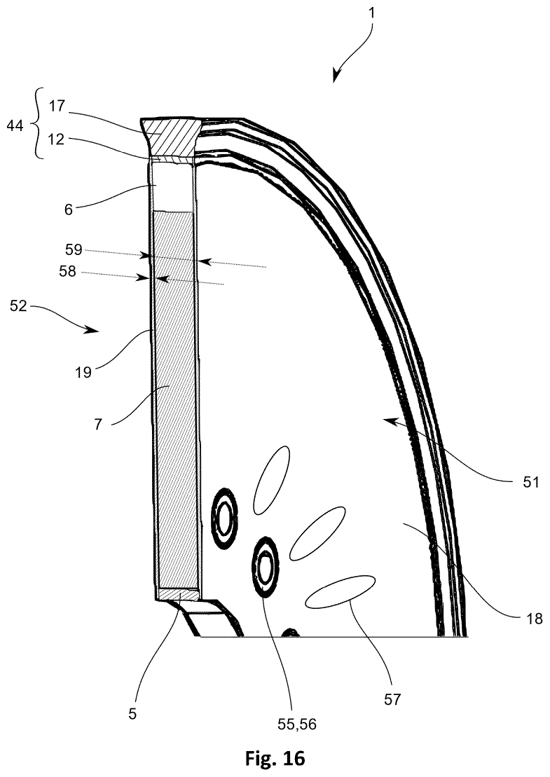

The reinforcing braces 7 are cuboidal and substantially identical. The reinforcing braces 7 are connected at least on one of their axial surfaces 50 to a cover disc 18, 19, which at least in part covers the rotor 1 on an end face 51 of the rotor, which can also be clearly seen from FIG. 16.

By introducing the radial reinforcing braces 7 parallel (relative to the load direction) to the magnet element load path, the magnetic load path can be closed via the bandage element 44, the rotor shaft 23 or the inner ring 5 and the contact ribs 60. By applying an equal prestress to the components involved at the operating point of the rotor 1, the reinforcing braces 7 contribute directly to the overall stiffness of the rotor 1. As a result, the radial stress amplitudes in the magnet elements and, if applicable, in their coupling elements 9 are reduced in magnitude. In addition, the overall radial stiffness of the rotor 1 increases (with respect to the magnet displacement per centrifugal load), which reduces the displacement amplitudes and thus the relative stresses between the components.

The reinforcing braces 7 thus introduce the magnetic centrifugal loads at further points via the outer ring 6 into the bandage element 444 in order to generate more uniform and less polygonally pronounced load introduction into the bandage. The magnetic forces are transmitted to the reinforcing braces 7 via the load paths “magnet element-cover disc-reinforcing brace” and “magnet element-coupling element-reinforcing brace”. The reinforcing braces 7 then introduce the loads into the bandage element 44.

The reinforcing braces 7 are prestressed against the bandage element 44 via an interference fit to the rotor shaft 23. Not only is a prestressing force introduced into the bandage element 44, but it is also polygonized in order to be able to absorb the operating forces more effectively (higher operating point stiffness than an originally round bandage element 44).

The reinforcing braces 7 are located between the two cover discs 18, 19, which can be clearly seen in FIG. 16. They serve as shear field transmitters for the cover discs 18, 19 in order to increase their effect on axial stiffness. This effect can be further increased by partially aligning the direction of some of the reinforcing fibers in the reinforcing braces 7 with the main load direction of the shear field. Of course, the reinforcing braces 7 also contribute directly to increasing the axial rotor stiffness through their own area moment of inertia.

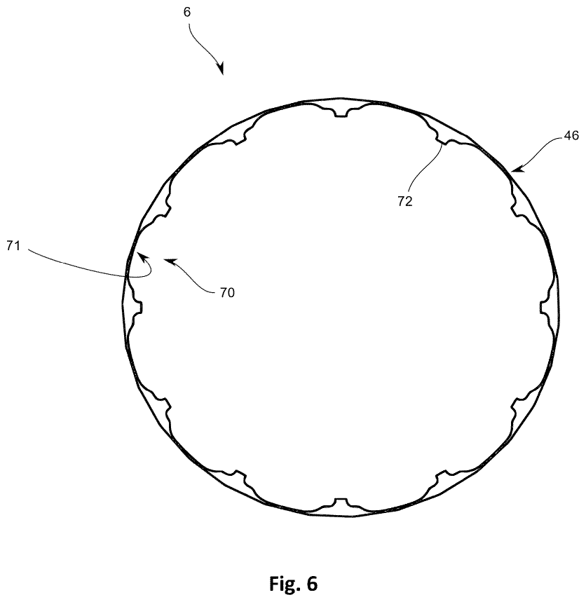

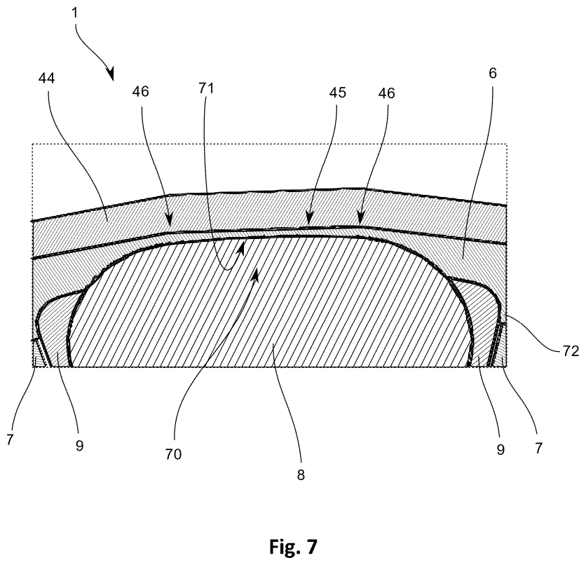

The outer ring 6, for example, can be clearly seen in FIGS. 6-7 and is described in more detail below. FIG. 7 shows the rotor 1, including a plurality of magnet elements 8, which are arranged circumferentially distributed in the rotor 1, wherein the magnet elements 8 are supported radially outwardly on an outer ring 6.

An annular bandage element 44 rests against the outer ring 6 by way of a press fit such that a prestress is introduced into the rotor 1 via the bandage element 44.

It is clearly visible from FIG. 6 that the outer ring 6 is formed as a fully closed ring. In principle, it would also be conceivable for the outer ring to be segmented. FIG. 6 further shows that the outer ring 6 includes a plurality of pockets 70, each of which has a contact surface 71 extending in the circumferential direction for a magnet element 8 and, on both sides of the magnet element 8 in the circumferential direction, each has a coupling portion 72 extending radially inward from the outer ring 6.

A reinforcing brace 7 extending in the radial direction to the outer ring 6 is arranged between each pair of circumferentially adjacent magnet elements 8. These reinforcing braces 7 are each supported in the radial direction on a coupling portion 72 of the outer ring 6.

The outer ring 6 has a polygonal circumferential outer contour 45 with a plurality of support points 46.

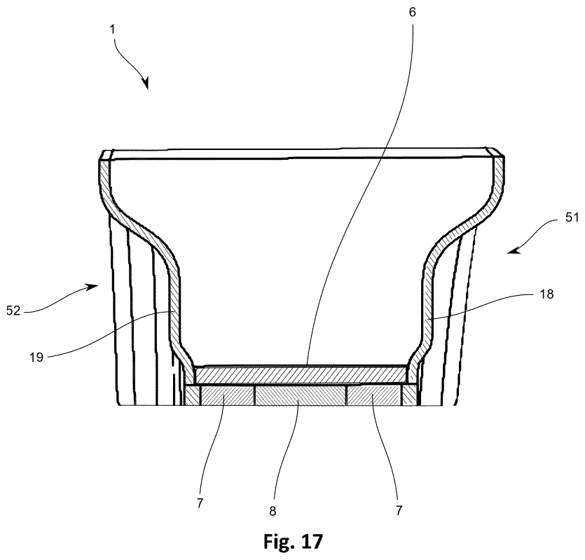

The cover discs 18, 19 are explained in more detail with reference to FIGS. 16-17. FIG. 16 shows a rotor 1 including an inner ring 5 and an outer ring 6 arranged coaxially thereto, and magnet elements 8 arranged between the inner ring 5 and the outer ring 6, wherein reinforcing braces 7 extending in the radial direction are arranged in the manner of spokes between the inner ring 5 and the outer ring 6.

In the circumferential direction, one of the magnet elements 8 is arranged on each side of a reinforcing brace 7 and is operatively connected to a reinforcing brace 7 in such a way that a force component caused by centrifugal force acting on the magnet elements 8 during operation of the rotor 1 can be transmitted from a magnet element 8 to a reinforcing brace 7 and/or vice versa.

At least one of the reinforcing braces 7 and/or at least one of the magnet elements 8 is connected to at least one cover disc 18, which at least in part covers the rotor 1 on a first end face 51 of the rotor 1 such that, during operation of the rotor, force can be transmitted from one of the reinforcing braces 7 and/or at least one of the magnet elements 8 to the at least one cover disc 18 and/or vice versa.

Furthermore, at least one of the reinforcing braces 7 and/or at least one of the magnet elements 8 is connected to at least one cover disc 19, which at least in part covers the rotor on a second end face 52 of the rotor 1 such that, during operation of the rotor 1, force can be transmitted from one of the reinforcing braces 7 and/or at least one of the magnet elements 8 to the at least one cover disc 19 and/or vice versa.

The cover disc 18 on the first end face 51 of the rotor 1 and the cover disc 19 on the second end face 52 of the rotor 1 are each formed as annular discs. The cover disc 18 on the first end face 51 of the rotor 1 and the cover disc 19 on the second end face 52 of the rotor 1 each have a mean axial extent 58 which corresponds to between 1 and 80% of the axial extent 59 of the magnet elements 8.

The cover disc 18 on the first end face 51 of the rotor 1 and the cover disc 19 on the second end face 52 of the rotor 1 have fastening means 55 by way of which torque can be transmitted from the rotor 1 to a rotor flange 16, via which the torque can be introduced into a rotor shaft 23. In the embodiment shown, the fastening means 55 include fastening openings 56 arranged equidistantly on a circular path. In the embodiment variant of the rotor 1 shown, the cover disc 18 on the first end face 51 of the rotor 1 and the cover disc 19 on the second end face 52 of the rotor 1 are substantially identical.

By attaching at least one cover disc 18, 19, the axial stiffness of the rotor 1 is increased, since the cover disc 18, 19 has a stiffness in its plane. By virtue of their connection to the rotor 1 and the load transmission via reinforcing braces 7 and/or magnet elements 8 and/or further rotor components, a shear field is transmitted at least into the rotor structure, to the respective other cover disc 18, 19. This results in an increase in the area moment of inertia and thus the axial stiffness of the rotor 1. The cover discs 18, 19 also effect a centrifugal load transmission from the magnet elements 8 via cover discs 18, 19 to the reinforcing braces 7 for uniform load introduction of the centrifugal loads into the outer ring 6 or the bandage element 44.

The cover discs 18, 19 also equalize the forces acting in the rotor 1 in the region of the flange connection. This allows the operating forces of the rotor 1 to be transmitted uniformly to the flange 16 via the contact surface. Likewise, the pressing forces of the flange connection can be uniformly applied to the rotor 1. Any auxiliary elements, such as knurls in the flange 16, can also engage in a cover disc 18, 19

FIG. 16 further shows that the cover disc 18 on the first end face 51 of the rotor 1 and/or the cover disc 19 on the second end face 52 of the rotor 1 can have curvatures 57 directed toward the inside or outside of the rotor 1, which result in a lower overall stiffness with respect to the radial rotor plane and can therefore locally relieve the cover discs 18, 19 or the rotor 1.

A radially inner region of a cover disc 18, 19, which is in contact with the flange 16, can be used as a machining layer in order to achieve a defined surface with desired properties to improve the connection to the flange 16.

FIG. 17 shows an embodiment variant in which the cover disc 18 on the first end face 51 of the rotor 1 and the cover disc 19 on the second end face 52 of the rotor 1 project radially beyond the edge of the outer ring 6 and a bandage element 44 rests axially on the outer ring 6 between the cover discs 18, 19. The cover discs 18, 19 can thus be used, for example, as a direct winding form or as an auxiliary form for the production of the load bandage 17. They can also act to protect the bandage element.

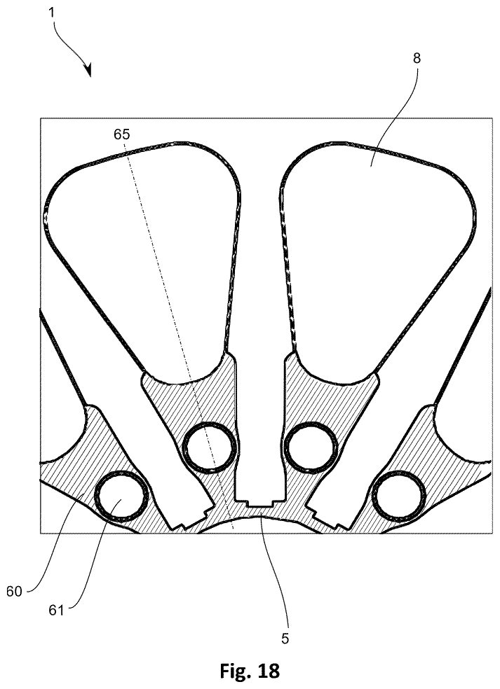

The inner ring 5 of the rotor 1 is explained in more detail with reference to FIG. 4 and FIG. 18. FIG. 18 shows the rotor 1 including a plurality of magnet elements 8, which are arranged circumferentially distributed in the rotor 1, wherein the magnet elements 8 are supported radially inwardly via the contact ribs 60 on an inner ring 5.

The rotor 1 further has an outer ring 6 arranged coaxially to the inner ring 5, on which the magnet elements 8 are supported radially outwardly, as can be seen in FIG. 4. A reinforcing brace 7 extending in the radial direction between the inner ring 5 and the outer ring 6 is arranged between each pair of circumferentially adjacent contact ribs 60.

A plurality of contact ribs 60 extend radially outwardly from the inner ring 5, wherein the magnet elements 8 are supported inwardly in the radial direction on the contact ribs 60. The number of contact ribs 60 corresponds to the number of magnet elements 8. The inner ring 5 and the contact ribs 60 are formed integrally, in particular monolithically, with one another. The inner ring 5 and the contact ribs 60 are formed by way of an extrusion method.

The inner ring 5 thus also connects the inner components of the rotor 1 in order to make them handleable, in particular, during the manufacturing process. The inner ring 5 thus provides a defined inner contour, in the embodiment shown a cylindrical inner contour, in order to be able to specifically receive the rotor 1 in a handling tool during the manufacturing process.

Each of the contact ribs 60 has an opening 61 which axially passes through the respective contact rib 60 and through which is passed a screw by way of which the rotor flange 16 can be connected to the rotor 1.

As can also be clearly seen from FIG. 18, the inner ring 5 with its contact ribs 60 and the magnet elements 8 supported thereon are each arranged in alignment and mirror-symmetrically along a radially extending axis of symmetry 65.

The inner ring 5 can also be removable or have been removed from the rotor 1, as can be seen in the embodiment variant of FIG. 19. For example, the inner ring 5 may have been fully machined by turning for this purpose.

The contact ribs 60 will now be described in more detail with reference to FIG. 4, FIG. 18 and FIG. 19.

FIG. 4 shows the rotor 1 including a plurality of magnet elements 8, which are arranged circumferentially distributed in the rotor 1, wherein the magnet elements 8 are supported radially inwardly on a plurality of contact ribs 60. The contact ribs 60 thus directly or indirectly create a form-fit connection to the corresponding magnet elements so as to be able to absorb and transmit its torque.

Furthermore, the contact ribs 60 make it possible to provide a defined axial stiffness of the rotor 1 in order, for example, to be able to establish a force-locking (axial) frictional connection to a cover disc 18, 19 in order to support the cover disc 18, 19 axially and to be able to transmit the torque.

In the embodiment shown, the number of magnet elements 8 corresponds to the number of contact ribs 60. The contact ribs 60 each have an opening 61 which axially passes through the respective contact rib 60, in order to transmit torque into a cover disc 18, 19 and/or a rotor flange 16 and/or to enable a screw connection. For this purpose, the opening can have an internal thread or be designed as a through hole.

Between each pair of circumferentially adjacent contact ribs 60, a reinforcing brace 7 extending in the radial direction is arranged, which projects radially outward from an inner ring 5. The contact ribs 60 are substantially identical.

The contact ribs 60 between the shaft connection and the magnet elements 8 can also allow the press fitting of the rotor shaft 23 to achieve the interference fit and frictional engagement with the magnet elements 8 and the rotor shaft 23. This in turn enables torque transmission to the rotor shaft 23.

Additionally or alternatively, form-fitting details can be provided at the contact point between the contact rib and the shaft interference fit in order to enable torque transmission and the torsion-proof fit of the contact ribs 60 on the rotor shaft 23. Thus, at least one contact rib 60 can have a form-fitting means 63 on its surface 62 facing radially inward toward a rotor shaft 23, via which a torque-transmitting connection between the rotor shaft 23 and the contact rib 60 can be established. The rotor 1 then has no inner ring 5, since the contact ribs 60 are directly coupled to the rotor shaft 23. This is shown in FIG. 19.

The contact ribs 60 thus also serve to transmit the contact rib/rotor shaft overlap by pressing in the rotor shaft in order to bring the load path rotor shaft-contact rib-magnet element-outer ring-bandage element into a favorable compressive prestress. The contact ribs 60 also serve as radial stiffness elements in the bracing diagram with, among others, the bandage element 44 and the reinforcing braces 7 in order to distribute the total load amplitude over various prestressed spring paths and thus to reduce the stress amplitude in the components involved. For this purpose, the radial stiffness of the contact ribs 60 is less than 92% of the radial stiffness of the magnet elements 8.

In all the embodiments shown, the rotor 1 does not contain any ferromagnetic material. The components of the rotor 1, with the exception of the magnet elements 8, therefore include a non-ferromagnetic material, such as plastic, ceramic, non-magnetic steel or aluminum. Most particularly, all the components from the group including the inner ring 5, the outer ring 6, the reinforcing braces 7, the coupling elements 9, the auxiliary bandage 12, the load bandage 17, the cover discs 18, 19 and the contact ribs 60 are made of a plastic.

The invention is not limited to the embodiments shown in the figures. The above description should therefore be regarded as explanatory rather than restrictive. The following claims are to be understood as meaning that a stated feature is present in at least one embodiment of the invention. This does not exclude the presence of further features. Where the claims and the above description define ‘first’ and ‘second’ features, this designation serves to distinguish between two features of the same type without defining an order of precedence.

### LIST OF REFERENCE SIGNS

1 Rotor
2 Axial flux machine
3 Powertrain
4 Motor vehicle
5 Inner ring
6 Outer ring
7 Reinforcing braces
8 Magnet elements
9 Coupling element
10 Thickness
11 Longitudinal surface
12 Auxiliary bandage
13 Connecting portion
14 Molding tool
15 Air gap
16 Flange
17 Load bandage
18 Cover disc
19 Cover disc
20 Flange ring
21 Compression limiter
22 Stator
23 Rotor shaft
24 Longitudinal extent
25 Circumferential contour
26 Side
27 Surface portion
28 Surface portion
29 Side
30 Surface portion
31 Surface portion
32 Plane
33 Plane
34 Plane
35 Plane
36 Chamfer
37 Axial surface
38 Structures
39 Surface portion
40 Surface portion
41 Chamfer
42 Region
43 Region
44 Bandage element
45 Contour
46 Support points
50 Axial surfaces
51 End face
52 End face
55 Fastening means
56 Fastening means
57 Curvatures
58 Extent
59 Extent
60 Contact ribs
61 Opening
62 Surface
63 Form-fitting means
65 Axis of symmetry
70 Pockets
71 Contact surface
72 Coupling portion

1. A rotor for an axial flux machine, comprising:
an inner ring an outer ring arranged coaxially thereto,
magnet elements arranged between the inner ring and the outer ring,
reinforcing braces extending between the inner ring and the outer ring in a radial direction and arranged in a manner of spokes, wherein a respective magnet element is arranged on both sides of each reinforcing brace in a circumferential direction and is operatively connected to the reinforcing brace such that a force component which is produced by a centrifugal force acting on the magnet elements during operation of the rotor is transmitted at least one of from a magnet element to a reinforcing brace or from the reinforcing brace to the magnet element.

2. The rotor according to claim 1, further comprising a coupling element is arranged on both sides of one of the reinforcing braces in the circumferential direction between one of the magnet elements and the corresponding reinforcing brace, wherein the coupling elements are formed from a material that differs from at least one of the inner ring, the outer ring 6, the magnet elements or the reinforcing braces.

3. The rotor according to claim 1, wherein at least one of the reinforcing braces is made of a plurality of parts.

4. The rotor according to claim 1, wherein at least one of the reinforcing braces is formed integrally with at least one of the inner ring or the outer ring.

5. The rotor according to claim 1, wherein at least one material of at least one reinforcing brace has a modulus of elasticity of greater than 6,000 MPa in a radial extension of the reinforcing brace.

6. The rotor according to claim 1, wherein at least one of the reinforcing braces is formed from at least one of a plastic, a fiber-reinforced plastic, a non-magnetic steel, aluminum, or a ceramic.

7. The rotor according to claim 1, wherein at least one of the reinforcing braces the magnet elements or the inner ring has a counteracting prestress relative to at least one of a load bandage or an auxiliary bandage at an operating point of the rotor.

8. The rotor according to claim 1, wherein at least one of the reinforcing braces is formed to be cuboidal.

9. The rotor according to claim 1, wherein a plurality of the reinforcing braces are identical.

10. The rotor according to claim 1, wherein at least one of the reinforcing braces is connected on at least one of its axial surface of the at least one of the reinforcing braces to a cover disc which at least partly covers the rotor on an end face of the rotor.

11. A vehicle powertrain comprising an axial flux machine having a rotor according to claim 1.

12. An axial flux machine for a vehicle powertrain, the axial flux machine comprising a rotor according to claim 1.

13. A rotor for an axial flux machine, comprising:
an inner ring;
an outer ring arranged coaxially to the inner ring;
a plurality of magnet elements arranged between the inner ring and the outer ring; and
a plurality of reinforcing braces extending between the inner ring and the outer ring in a radial direction,
wherein a respective magnet element is arranged on both sides of each reinforcing brace in a circumferential direction and is operatively connected to the reinforcing brace such that a force component which is produced by a centrifugal force acting on the magnet elements during operation of the rotor is transmitted at least one of from a magnet element to a reinforcing brace or from the reinforcing brace to the magnet element.
